(19) United States
(12) Patent Application Publication
(10) Pub. No.: US 2014/0136381 A1
(43) Pub. Date: May 15, 2014

(54) Financial Management Platform

(71) Applicants: Ramya Joseph, Larchmont, NY (US); Joe Abraham, New Rochelle, NY (US)

(72) Inventors: Ramya Joseph, Larchmont, NY (US); Joe Abraham, New Rochelle, NY (US)

(73) Assignee: Brooktrail Technologies LLC

(21) Appl. No.: 13/677,559

(22) Filed: Nov. 15, 2012

(51) Int. Cl. G06Q 40/02

(52) U.S. Cl. CPC G06Q 40/02
USPC 705/35

(57) ABSTRACT

A computer implemented method and system for managing financial data (FD) in real time provides a financial management platform (FMP) that aggregates and categorizes FD from financial user accounts and generates an N-dimensional financial format (NDFF) to store and render the aggregated and categorized FD in a transformed and modifiably categorized configuration on a graphical user interface (GUI). The FMP computes current metrics using the aggregated and categorized FD. The FMP dynamically adapts the current metrics to reflect changes caused by user interactions with interactive components and visualizations of the rendered FD in the NDFF on the GUI. The FMP generates dynamic real-time financial projections based on the computed and adapted current metrics and configurable parameters. A business intelligence platform integrated with the FMP provides real-time access of FMP FD and computations to third parties for analysis, real-time adaptation of business decisions, and financial regulation and monitoring of financial institutions.

### CROSS REFERENCE TO RELATED APPLICATIONS

This application claims the benefit of provisional patent application No. 61/560,296 titled “Financial Management Platform”, filed on Nov. 16, 2011 in the United States Patent and Trademark Office.

The specification of the above referenced patent application is incorporated herein by reference in its entirety.

### BACKGROUND

A conventional personal financial management (PFM) system manages finances of multiple users, where each of the users is associated with one or more financial accounts held at various financial institutions, for example, banks, investment firms, credit unions, insurance agencies, brokerages, etc. Typically, each of the users accesses and uses applications of the PFM system through a user interface portal on a registered website over the internet. The user interface of a conventional PFM system supports some user interaction, but does not provide support for complex real-time user interaction and decision analysis. The PFM system aggregates data from a user's financial accounts, internally or via a third party service, and holds the aggregated data in a centralized manner as raw financial data. Optionally, the raw financial data may be further scrubbed and categorized for consumption by an application layer of the PFM system. The application layer of the PFM system encompasses common features, for example, budgeting and spending analysis, goal management, current metrics, and financial product distribution. Budgeting and spending analysis refers to a feature of the personal financial management (PFM) system that gathers transaction data from financial accounts such as credit card accounts and debit card accounts and groups the transaction data into broad categories. The user can then look at past spending over time, set future spending targets, and track the progress of the targets against future transactions.

Goal management refers to a feature that allows the user to set aside funds to save for a large monetary expense. Typically, the user inputs a dollar amount as a goal. In most PFM systems, the user is then requested to link the goal to a separate financial account such as a savings account. Therefore, these PFM systems manage goals by assigning a one-to-one mapping between a single goal and a single financial account. The goal is then tracked by tracking the required goal amount against the balance in the underlying financial account. In conventional PFM systems, planning for an event, for example, college, retirement, etc., is often performed by setting aside funds for the event through a goal. Conventional PFM systems allow users to analyze the events independently of each other, do not connect or chain the events together so that the user understands the impact of one event on another, and do not analyze the related trade-offs and resource consumption across multiple events holistically.

Another feature of the PFM system referred to as “current metrics” gathers the raw financial data of a financial account and computes snapshot values. The snapshot values are typically based on the user's existing financial accounts, are not projected in time, and do not change in real time as the user interacts with the PFM system. Typical examples of “current metrics” include total asset value and net worth. With regard to financial product distribution, conventional PFM systems typically propose financial products to users through online advertisements. Although third party organizations such as financial institutions may create advertisements that are displayed on the PFM system, they do not integrate the advertisements with the data and business processes of the third party organizations. If a user purchases a product by clicking on the advertisement, the PFM system obtains part of lead generation revenues. The conventional PFM systems provide limited guidance to the user on whether the product would be appropriate for their current financial situation and long term financial picture.

Hence, there is a long felt but unresolved need for a computer implemented method and system that manages financial data of a user in real time, tracks and manages personal finances of the user, provides user interaction driven real-time decision support for both the user's current finances and future projected finances, provides visualizations that facilitate real-time user interactions, adapts the PFM system based on the user interactions automatically in real time, provides a chained impact of events and related trade-off analysis, and enables enhanced budgeting and spending analyses, goal management, computation of current metrics, and financial product distribution in the application layer.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and system disclosed herein address the above stated needs for managing financial data of a user in real time, tracking and managing personal finances of the user, providing user interaction driven real-time decision support for both the user's current finances and future projected finances, providing visualizations that facilitate real-time user interactions, adapting a personal financial management system based on the user interactions automatically in real time, providing a chained impact of events and related trade-off analysis, and enabling enhanced budgeting and spending analyses, goal management, computation of current metrics, and financial product distribution in an application layer of the personal financial management system. The financial data of the user comprises, for example, financial inputs acquired from the user or financial account data such as bank account details, investment account details, mortgage details, real estate details, etc., aggregated from one or more financial institutions of the user, through permissions obtained from the user.

The computer implemented method and system disclosed herein provide a financial management platform comprising at least one processor configured to manage the financial data in real time. The financial management platform is accessible by one or more user devices via a network. The user devices comprise, for example, personal computers, tablet computing devices, mobile phones, smart phones, laptops, personal digital assistants, touch centric devices, network enabled computing devices, etc. The computer implemented method and system disclosed herein also provide multiple interactive components on a graphical user interface (GUI) of the financial management platform. As used herein, the term “interactive components” refers to design paradigms or interface elements on the GUI configured to perform a combination of processes, for example, a data retrieval process from an N-dimensional financial format generated by the financial management platform, processes that translate retrieved data into a visual entity, for example, a radial graph representation of a mirror model, a dynamic timeline graph, etc., on the GUI, processes that enable real-time user interactions with the associated visualizations, where the user interactions are associated with computational algorithms that automatically modify the underlying financial data in the N-dimensional financial format based on the user interactions and reflect the modifications on the visual entity concurrently, etc. The interactive components are configured to acquire user interactions with the financial data on the GUI.

The financial management platform aggregates and categorizes financial data from multiple financial user accounts. The financial management platform categorizes the financial data based on characteristics of the user's financial data. For example, the financial management platform categorizes bank account transactions under a particular spending category or a sub-category. In another example, the financial management platform categorizes investment account holdings under a particular asset category, class, or subclass. The financial management platform generates an N-dimensional financial format configured to store and render the aggregated and categorized financial data in a transformed and modifiably categorized configuration on the GUI. As used herein, the term “N-dimensional financial format” refers to a format implemented as an in-memory indexed data structure, for example, using object oriented data structures configured to store and query financial data across multiple dimensions. The N-dimensional financial format is configured to facilitate multiple real-time permutations of the aggregated and categorized financial data, and computations against the aggregated and categorized financial data.

The financial management platform computes current metrics using the aggregated and categorized financial data stored in the N-dimensional financial format. As used herein, the term “current metrics” refers to values that measure aspects of financial data, for example, total spending, net worth, etc. The financial management platform dynamically adapts the computed current metrics in real time to reflect changes caused by user interactions with one or more of the interactive components and associated visualizations of the rendered financial data in the N-dimensional financial format on the GUI. The financial management platform supports the user interactions on the GUI through the interactive components and the visualizations of the financial data in the N-dimensional financial format. The financial management platform renders the interactive components and the visualizations of the financial data in the N-dimensional financial format to the user via the GUI. The financial management platform acquires user inputs via the GUI, for example, through the interactive components. The financial management platform is configured to overlay the acquired user inputs on the rendered financial data in the N-dimensional financial format to perform a prospective analysis of financial decisions and determine current financial status and future financial status.

The financial management platform generates dynamic real-time financial projections based on the computer current metrics, the dynamically adapted current metrics, and one or more configurable parameters. The configurable parameters for generating the dynamic real-time financial projections comprise, for example, user events, market events, personal events, a product recommendation overlay, etc., and any combination thereof. The dynamic real-time financial projections create financial metrics over many years in the future. The financial management platform performs a comparative analysis of the user events collectively dependent on each other to determine and display impact of one of the user events on another one or more of the user events on the GUI. In an embodiment, the financial management platform generates a dynamic timeline graph configured to render the computed current metrics, the dynamically adapted current metrics, and the generated dynamic real-time financial projections on the GUI to the user, for visualization by the user. The dynamic timeline graph is further configured to support direct real-time user interactions with the computed current metrics, the dynamically adapted current metrics, and the generated dynamic real-time financial projections on the GUI. In another embodiment, the financial management platform adjusts the generated dynamic real-time financial projections to account for changes, for example, in one or more of current tax rates, future tax rates, inflation rates, foreign exchange rates, etc., and any combination thereof.

In an embodiment, the financial management platform generates one or more financial goals as a result of user interactions through one or more of the interactive components and visualizations, for example, minor modeling, user events, market events, scenarios, a product recommendation overlay, etc. The financial management platform is configured to collectively prioritize, manage, and track each of the generated financial goals against a superset of the financial user accounts to determine financial feasibility of the user interactions made through the interactive components and the visualizations.

In an embodiment, the financial management platform generates an optimized refinanced debt structure, for example, based on one or more of loan information provided by one or more financial institutions such as banks, credit unions, insurance agencies, investment firms, brokerages, etc., a user's existing debt structure, a user's liquid assets, etc. The financial management platform generates the optimized refinanced debt structure, for example, by generating an interest rate structure using user configurable filters on the loan information. In another embodiment, the financial management platform categorizes transaction data of the financial user accounts extracted from the aggregated and categorized financial data into spend categories, acquires boundary conditions on spending for each of the spend categories to generate a budget, and facilitates tracking of the generated budget against subsequent spending.

In an embodiment, the financial management platform integrates with a business intelligence platform comprising at least one processor. The business intelligence platform is accessible by one or more of multiple third parties via a network. The financial management platform is configured to provide real-time access of financial information comprising the aggregated and categorized financial data, the computed current metrics, the dynamically adapted current metrics, results of the user interactions with the interactive components and the visualizations of the rendered financial data in the N-dimensional financial format, and the generated dynamic real-time financial projections, to the business intelligence platform and to the third parties via the business intelligence platform for one or more of performing data analysis and market segmentation analysis, adapting business decisions in real time, and monitoring financial institutions associated with the financial user accounts.

In an embodiment, the business intelligence platform receives one or more recommendations on one or more products, services, and investment ideas made by one or more of the third parties using the real-time access of the financial information, via one or more application programming interfaces (APIs) of the financial management platform. The financial management platform, in communication with the business intelligence platform, is configured to transmit the received recommendations to the user devices via the network. The business intelligence platform facilitates real-time communication between the user devices and one or more financial institutions and among the third parties via the network in one or more multiple communication modes. The communication modes are, for example, a messaging mode, a chat mode, an electronic mail mode, a video mode, an audio mode, a telephonic mode, etc. In an embodiment, the business intelligence platform categorizes business intelligence data and user interactions with the third parties into one or more categories across time based on predetermined criteria. The predetermined criteria comprise, for example, one or more of user demographics, type of investment ideas, the financial institutions associated with the financial user accounts, attributes of the financial data, etc., and any combination thereof, for determining and analyzing consumer trends. In an embodiment, the business intelligence platform generates analytical reports based on changes in the aggregated and categorized financial data, market data, and economic data.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for managing financial data of a user in real time.

FIG. 2 illustrates a block diagram showing data flows through a financial management system during management of financial data of a user in real time.

FIG. 3 exemplarily illustrates a computer implemented system for managing financial data of a user in real time.

FIG. 4 exemplarily illustrates the architecture of a computer system employed by the financial management system for managing financial data of a user in real time.

FIG. 5 exemplarily illustrates a graphical visualization of financial metrics data rendered by a financial management platform based on mirror modeling.

FIG. 6 exemplarily illustrates a dynamic timeline graph generated by the financial management platform, showing past, present, and projected personal financial metrics over time.

FIG. 7 exemplarily illustrates a financial institution loan table sourced from financial institutions.

FIGS. 8A-8B exemplarily illustrate a table showing financial data aggregated from financial user accounts.

FIGS. 9A-9C exemplarily illustrate a table showing aggregated and categorized financial data stored in an N-dimensional financial format in a transformed and modifiably categorized configuration.

FIG. 10 exemplarily illustrates a table showing current metrics computed using aggregated and categorized financial data stored in an N-dimensional financial format.

FIG. 11 exemplarily illustrates a table showing dynamic financial projections of the current metrics generated by the financial management platform.

FIG. 12 exemplarily illustrates a table showing current metrics and financial projections of the current metrics dynamically adapted based on changes caused by user interactions with one or more interactive components, visualizations, and configurable parameters.

### DETAILED DESCRIPTION OF THE INVENTION

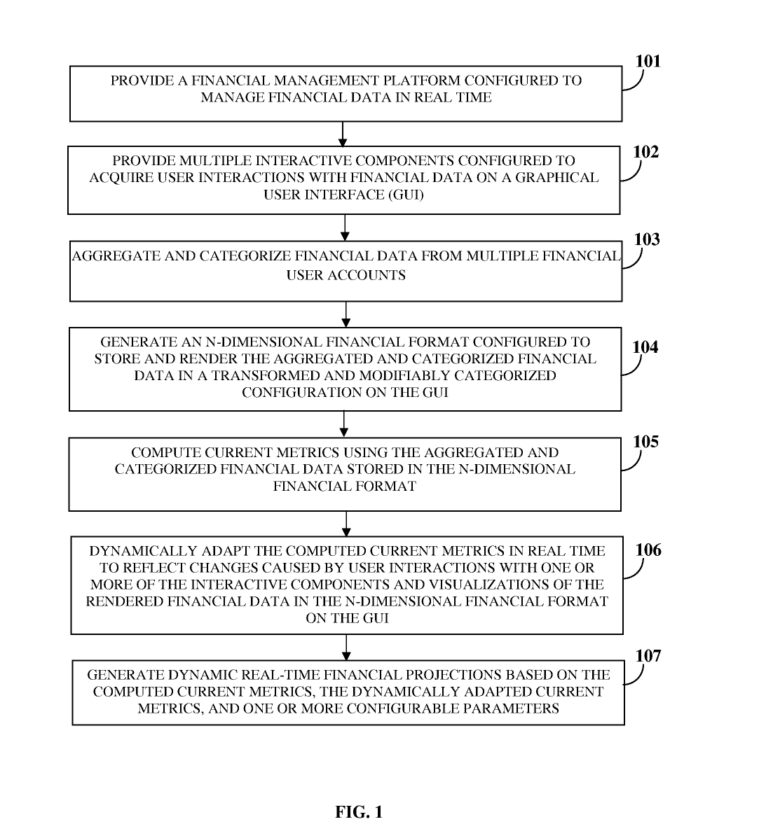

FIG. 1 illustrates a computer implemented method for managing financial data of a user in real time. The user's financial data comprises, for example, financial inputs acquired from the user or financial account data such as bank account details, investment account details, mortgage details, real estate details, etc., aggregated from one or more of the user's financial institutions, through permissions obtained from the user. The computer implemented method disclosed herein provides 101 a financial management platform comprising at least one processor configured to manage the financial data in real time. In an embodiment, the financial management platform is a web based platform hosted on a server or a network of servers. In another embodiment, the financial management platform is configured as a software application downloadable on a user device. The financial management platform is accessible by one or more user devices via a network. The user devices comprise, for example, a computer, a tablet computing device, a mobile phone, a smart phone, a personal digital assistant, a touch centric device, a network enabled computing device, etc. The network is, for example, a wired network, a wireless network, a communication network that implements Bluetooth® of Bluetooth Sig, Inc., a network that implements Wi-Fi® of the Wireless Ethernet Compatibility Alliance, Inc., an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, etc., a local area communication network, an internet connection network, an infrared communication network, etc. The financial management platform is a web-enabled system accessible on any user device that supports internet based applications. The financial management platform is accessible to the user, for example, through a broad spectrum of technologies and devices such as personal computers with access to the internet, internet enabled cellular phones, tablet computing devices, etc. The financial management platform can be accessed and used without any modification or installation required by a user device manufacturer or an end user or an end consumer.

The computer implemented method disclosed herein also provides 102 multiple interactive components on a graphical user interface (GUI) of the financial management platform. As used herein, the term “interactive components” refers to design paradigms or interface elements on the GUI configured to perform a combination of processes, for example, a data retrieval process from an N-dimensional financial format generated by the financial management platform, processes that translate retrieved data into a visual entity, for example, a radial graph representation of a mirror model, a dynamic timeline graph, etc., on the GUI, processes that enable real-time user interactions with the associated visualizations, where the user interactions are associated with computational algorithms that automatically modify the underlying financial data in the N-dimensional financial format based on the user interactions and reflect the modifications on the visual entity concurrently, etc. The interactive components are configured to acquire user input via user interactions with the financial data on the GUI. The financial management platform aggregates and categorizes 103 financial data from multiple financial user accounts of the user. The financial user accounts are held at various financial institutions, for example, banks, credit unions, insurance agencies, investment firms, brokerages, etc. The financial management platform aggregates the financial data from multiple different financial user accounts in a centralized manner, that is, in a central location hosted by the financial management platform. The financial management platform categorizes the underlying financial data based on characteristics of the user's financial data. For example, the financial management platform categorizes bank account transactions under a particular spending category or a sub-category. In another example, the financial management platform categorizes investment account holdings under a particular asset category, class, or subclass.

The financial management platform generates 104 an N-dimensional financial format configured to store and render the aggregated and categorized financial data in a transformed and modifiably categorized configuration on the GUI. As used herein, the term “N-dimensional financial format” refers to a format implemented as an in-memory indexed data structure, for example, using object oriented data structures configured to store and query financial data across multiple dimensions. The data structures comprise, for example, dictionary, hash table and script oriented data structures such as JavaScript® objects. The financial management platform stores the aggregated financial data in a database, for example, a structured query language (SQL) data store or a not only SQL (NoSQL) data store such as the Microsoft® SQL Server®, the Oracle® servers, the MySQL® database of MySQL AB Company, the mongoDB® of 10gen, Inc., the Neo4j graph database, the Cassandra database of the Apache Software Foundation, the HBase™ database of the Apache Software Foundation, etc. The financial management platform accesses the aggregated financial data programmatically to form the N-dimensional financial format. The N-dimensional financial format stores the aggregated financial data of the user across time, that is, the actual financial data of the user from the past, and the projected financial data for the user in the future. The user's financial data can therefore be queried across time. The N-dimensional financial format enables performing dynamic computations against categorizations of the aggregated financial data to provide meaningful results. For example, the sum of spending categories for any specific time “t” would provide the total spending of the user at that time. In an embodiment, the financial management platform achieves dynamic computations against the aggregated and categorized financial data by using dynamic in-memory maps of the relationships between the categorized underlying financial data. The dynamic in-memory maps enable the N-dimensional financial format to be flexible with respect to relationships and hierarchies of the categorizations of the aggregated financial data.

The N-dimensional financial format is implemented at different granularities both on a server hosting the financial management platform and on a client, for example, a web browser of the user device, to enable real-time management of the user's financial data in a performant manner. The N-dimensional financial format on the server is cached on a per user basis using distributed caching technologies, for example, the Microsoft® AppFabric for Windows Server® of Microsoft Corporation, the memcached memory caching system, etc. Part of the N-dimensional financial format is also stored in a NoSQL datastore, for example, the mongoDB® of 10gen, Inc., the Neo4j graph database, the Cassandra database, the HBase™ database, etc., for enhanced queriability. The client, for example, the web browser on the user device, queries the financial management platform for the N-dimensional financial format, for example, through web service endpoints. The financial management platform transmits the queried N-dimensional financial format to the client in a format, for example, an extensible markup language (XML) format, a JavaScript® object notation (JSON) format, etc., which is translated into queriable client side JavaScript® objects. The combined server and client side implementation forms the N-dimensional financial format to be consumed by the financial management platform.

The N-dimensional financial format aggregates and stores the user's financial data across multiple dimensions. The underlying object structure of the N-dimensional financial format is multi-dimensional and is configured to facilitate multiple real-time permutations of the aggregated and categorized financial data, and computations against the aggregated and categorized financial data. Whenever a user updates, inserts, or deletes financial user accounts, the underlying aggregated financial data and associated categorizations in the N-dimensional financial format change in real time. User interactions with the interactive components and visualizations of the rendered financial data in the N-dimensional financial format also update the underlying financial data in the N-dimensional financial format.

The financial management platform provides a real-time financial modeling (RTFM) tool and a real-time financial picture (RTFP) tool for managing the financial data of the user. The RTFM tool and the RTFP tool compute the current metrics and generate financial projections respectively, using the aggregated and categorized financial data in the N-dimensional financial format automatically in real time. As the data in the N-dimensional financial format changes, the computations made by the RTFM tool and the RTFP tool are updated in real time. The flexibility of the categorizations of the aggregated financial data in the N-dimensional financial format, the multi-dimensional object structure of the N-dimensional financial format, and the distributed implementation of the N-dimensional financial format on the server and the client enable the RTFM tool and the RTFP tool to perform multiple real-time permutations of the aggregated and categorized financial data in the N-dimensional financial format and multiple real-time computations against the aggregated and categorized financial data in the N-dimensional financial format in a performant manner. The RTFM tool and the RTFP tool are operably implemented on the client, for example, the web browser and on the server, thereby enabling distribution of load between the client and the server, and thus optimizing the computational speed of the calculations performed by the RTFM tool and the RTFP tool.

The financial management platform computes 105 current metrics using the aggregated and categorized financial data stored in the N-dimensional financial format. As used herein, the term “current metrics” refers to values that measure aspects of financial data, for example, total spending, net worth, etc. The financial management platform transforms raw financial data and computes current snapshot values of the financial data. The financial management platform computes the current metrics directly from the aggregated and categorized financial data in the N-dimensional financial format. The financial management platform dynamically adapts 106 the computed current metrics in real time to reflect changes caused by user interactions with one or more of the interactive components and visualizations of the rendered financial data in the N-dimensional financial format on the GUI. The financial management platform updates the current metrics automatically to reflect user interaction driven changes. The user interaction driven changes result from the user interactions with the interactive components and visualizations of the rendered financial data in the N-dimensional financial format on the GUI. The user interactions can be combined in one or more methods and applied against the financial data in the N-dimensional financial format to compute and render the combined total effect on the GUI. The visualizations provide the user with the joint results of the combined user interactions. The interactive components and the visualizations allow the user to understand the effects without having to perform real-world transactions or real-world changes to the financial data in the financial user accounts that is aggregated in the N-dimensional financial format. The user inputs to the computations can be specified to occur, for example, on a current day or at a future date.

The user interacts with the interactive components and the visualizations of the financial data stored in the N-dimensional financial format, which are rendered by the RTFM tool and the RTFP tool of the financial management platform. The RTFM tool and the RTFP tool of the financial management platform render the interactive components and the visualizations of the financial data in the N-dimensional financial format to the user, for example, through one or more of minor modeling, modeling based on user events, modeling based on market events, modeling based on a product recommendation overlay, etc. The modeling based on the user events comprises performing a comparative analysis of the user events collectively dependent on each other to determine and display impact of one of the user events on another one or more of the user events on the GUI. The updates to the current metrics as a result of user interaction driven updates results in generation of the adapted current metrics. The RTFM tool assimilates and merges the results of multiple user interactions using proprietary data structures and calculations to arrive at a single cohesive set of current metrics. The RTFM tool assimilates and merges these results using calculations to provide the end user with a comprehensive, real-time financial picture showing the total effects of the user's interactions and changes. The RTFM tool also performs this assimilation in real time in a concurrent manner.

The current metrics and financial projections computed by the RTFM tool and the RTFP tool respectively, are dynamic in nature. The RTFM tool re-computes the current metrics in real time to reflect the changes made by the user interactions with the RTFM tool and the RTFP tool. The user can therefore visualize the impact of the user's interactions with the financial management platform in real time. The RTFP tool of the financial management platform consumes the current metrics and the adapted current metrics in real time as they are computed by the RTFM tool. The RTFP tool projects these values into the future across multiple time horizons.

The RTFP tool of the financial management platform generates 107 dynamic real-time financial projections of the user's personal finances based on the computed current metrics, the dynamically adapted current metrics, and one or more configurable parameters. The configurable parameters for generating the dynamic real-time financial projections comprise, for example, user events, market events, a product recommendation overlay, etc., and any combination thereof. The dynamic real-time financial projections are computed through calculations that combine the current metrics and any of the adapted current metrics with market data and economic data. As used herein, the term “market data” refers to data, for example, pricing, investment, etc., pertaining to trades. Also, as used herein, the term “economic data” refers to data pertaining to a present economy or a past economy. In an example, the RTFP tool analyzes current finances of the user and generates dynamic real-time financial projections for several years into the future, for example, 25 years or more, using quantitative statistical and econometric techniques.

In an embodiment, the financial management platform generates a graphical visualization, for example, a two-dimensional dynamic timeline graph configured to render the computed current metrics, the dynamically adapted current metrics, and the generated dynamic real-time financial projections on the GUI. The financial management platform displays the generated dynamic timeline graph on the GUI for visualization by the user. The dynamic timeline graph is further configured to support direct real-time user interactions with the computed current metrics, the dynamically adapted current metrics, and the generated dynamic real-time financial projections on the GUI. For example, the RTFM tool supports and facilitates real-time user interactions, computations, and decision analysis between user account data, market data, economic data, and user decision parameters, and performs computations against the results of the user interactions to provide the user with an understanding of the impact of the results on the user's financial status. The RTFP tool acquires the results as computed by the RTFM tool and generates the two-dimensional dynamic timeline graph for supporting direct real-time interaction between the user and the RTFP tool. In an embodiment, the RTFP tool adjusts the generated dynamic real-time financial projections to account for changes, for example, in one or more of current tax rates, future tax rates, inflation rates, foreign exchange rates, etc., and any combination thereof.

In an embodiment, the financial management platform categorizes transaction data of the financial user accounts extracted from the aggregated and categorized financial data into spend categories, acquires boundary conditions on spending for each of the spend categories to generate a budget, and facilitates tracking of the generated budget against subsequent spending. In another embodiment, the financial management platform generates one or more financial goals as a result of user interactions through one or more of the interactive components and visualizations such as user events, market scenarios, and mirror modeling. The financial goals generated by the financial management platform are automatically generated results of the user interactions. In an embodiment, users may also enter financial goals as one-off entities on the GUI. The financial management platform collectively prioritizes, manages, and tracks each of the generated financial goals against a superset of the financial user accounts to determine financial feasibility of the user interactions made through the interactive components and the visualizations. In another embodiment, the financial management platform generates an optimized refinanced debt structure, for example, based on one or more of loan information provided by one or more financial institutions, a user's existing debt structure, the user's liquid assets, etc. The financial management platform generates the optimized refinanced debt structure, for example, by generating an interest rate structure using user configurable filters on the loan information.

The financial management platform acquires user inputs via the GUI using interactive visual techniques. The financial management platform is configured to overlay the acquired user inputs on the rendered financial data in the N-dimensional financial format to perform a prospective analysis of financial decisions and determine current financial status and future financial status. In an example, the financial management platform overlays the acquired user inputs on the rendered financial data to perform a “What if?” type of analysis of financial decisions without the user engaging in a transaction or modification of the financial user accounts to obtain the results. In another example, the financial management platform overlays financial decisions such as increasing or decreasing spending, changing asset or investment allocation decisions, making a payment towards a debt, commencing with a debt, adding life events, adding multiple economic scenarios to a current financial picture, etc., without having to perform actual financial transactions or modifications to the underlying financial user accounts. The financial management platform schedules the overlays to occur in a timely manner, for example, to occur on a future date.

In another embodiment, the financial management platform generates visual techniques such as “See what a financial institution sees” to communicate to the user, the specific information that is being shared with third parties, for example, banks. By performing a user action such as clicking on a button, a checkbox, a radio button, etc., on the GUI, the user's financial data stored within the financial management platform that is being shared with the third parties, is visually highlighted differently from the data stored within the financial management platform that is not being shared, to allow the user to instantly visually understand the financial data being shared.

In addition to being a stand-alone consumer facing personal financial management platform, the financial management platform can directly integrate with third parties such as financial institutions and regulatory agencies that serve consumers. In an embodiment, the financial management platform integrates with a business intelligence platform comprising at least one processor. In an embodiment, the business intelligence platform is incorporated as a part of the financial management platform. In another embodiment, the business intelligence platform communicates with the financial management platform via a network. The business intelligence platform is accessible by one or more of multiple third parties via the network. Examples of third parties comprise financial institutions such as banks, credit unions, insurance providers, government agencies, regulators, etc. The financial management platform is configured to provide real-time access of financial information comprising, for example, the aggregated and categorized financial data, the computed current metrics, the dynamically adapted current metrics, results of the user interactions with one or more of the interactive components and the visualizations of the rendered financial data in the N-dimensional financial format, the generated dynamic real-time financial projections, etc., to the business intelligence platform and to one or more of the third parties via the business intelligence platform for one or more of performing data analysis, market segmentation analysis, etc., adapting business decisions in real time, and monitoring financial institutions associated with the financial user accounts. The third parties can access the financial information and computations in real time and use that data to perform business analysis and use the data for commercial purposes such as offering products and services to a user on a real-time basis.

The business intelligence platform is directly integrated with the financial management platform to allow third parties to have access to the financial information in real time and as the financial information changes, and to adapt their business decisions in real time to the changing financial data. For example, financial institutions segment the financial data against changing criteria such as income, net worth, credit score, future user events, retirement age, etc., and target products to users in a specific and cost-efficient manner even as the underlying financial data changes in real time. The distribution and proposal of products can therefore be performed on an automated, data-driven basis as opposed to more conventional methods based on one-to-one personal interaction that do not use technology interfaces to determine products that would be most appropriate for a user.

In an embodiment, the business intelligence platform receives one or more recommendations on one or more products, services, and investment ideas made by one or more third parties using the real-time access of the financial information, via one or more application programming interfaces (APIs) of the financial management platform. For example, the business intelligence platform allows third parties to access the financial information to perform analysis and use the financial information for offering products and services to the user of the financial management platform on a real-time basis. The financial management platform, in communication with the business intelligence platform, is configured to transmit the received recommendations to one or more user devices via the network.

The third parties create the recommendations through the APIs of the financial management platform. In an embodiment, the financial management platform transmits the recommendations created by the third parties directly to the user devices. The business intelligence platform allows third parties to recommend one or more products, services, and investment ideas to users of the financial management platform. These recommendations are made in an automated, computerized method via one or more APIs of the financial management platform. The APIs provided by the financial management platform allow third parties to submit relevant product characteristics, and market and economic features of a recommendation to the financial management platform such that the financial management platform can automatically compute the impact on the current metrics and the adapted current metrics prior to the user performing real-world financial transactions associated with the recommendation. For example, a financial advisor recommends a refinanced mortgage structure based on criteria transmitted by the financial management platform. The financial advisor uses the APIs to submit the recommendations such as new refinance rate, fees, etc., and the submitted data is consumed by the financial management platform. The financial management platform updates the current metrics, the dynamically adapted current metrics, and the generated dynamic real-time financial projections to reflect the impact of the recommendation prior to the user making a decision to commit to the refinanced mortgage structure.

In another embodiment, the business intelligence platform facilitates individual and mass real-time communication between the user devices and one or more financial institutions and among the third parties via the network in one or more of multiple communication modes. The communication modes are, for example, a messaging mode, a chat mode, an electronic mail mode, a video mode, an audio mode, a telephonic mode, etc. Furthermore, the business intelligence platform facilitates real-time data flows and communication between levels of third party organizations such as that of managers, subordinates, etc. In an embodiment, the business intelligence platform categorizes business intelligence data and user interactions with the third parties into one or more categories across time based on predetermined criteria. The predetermined criteria comprise, for example, one or more of user demographics, type of investment ideas, the financial institutions associated with the financial user accounts, attributes of the financial data, etc., and any combination thereof, for determining and analyzing consumer trends. In an embodiment, the business intelligence platform generates analytical reports based on changes in the aggregated and categorized financial data, market data, economic data, etc.

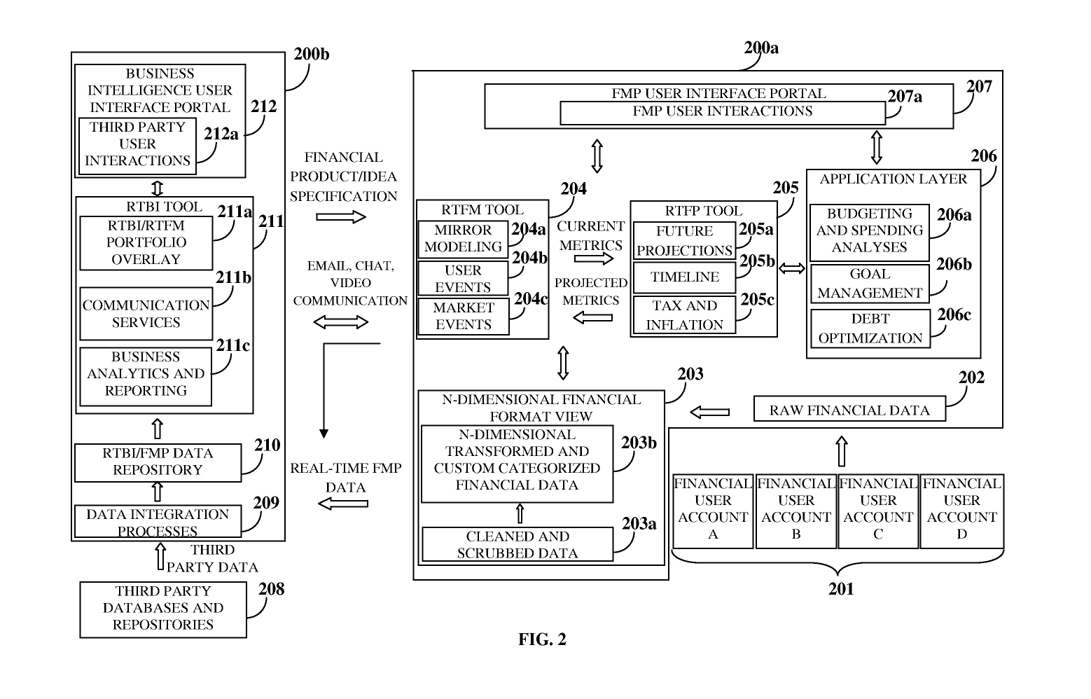

FIG. 2 exemplarily illustrates a block diagram showing data flows through a financial management system during management of financial data of a user in real time. The financial management system disclosed herein comprises the financial management platform (FMP) accessible by one or more user devices, for example, via the internet, through an FMP user interface portal 207 provided on the graphical user interface (GUI) of the financial management platform, and the business intelligence platform accessible by one or more third party computing devices, for example, via the internet, through a business intelligence user interface portal 212. The block diagram in FIG. 2 exemplarily illustrates the data flows within and between blocks 200a and 200b associated with the financial management platform and the business intelligence platform respectively.

The financial management platform aggregates raw financial data 202 from multiple financial user accounts A, B, C, and D 201, refines the financial data to generate cleaned and scrubbed data 203a, and generates an N-dimensional financial format view 203 of the N-dimensional transformed and custom categorized financial data 203b stored in an N-dimensional financial format. The N-dimensional financial format is configured to store and render the aggregated financial data in a transformed and modifiably categorized configuration on the GUI. The financial management platform enables enhanced budgeting and spending analyses 206a, goal management 206b, and debt optimization 206c in the application layer 206. The real-time financial modeling (RTFM) tool 204 of the financial management platform consumes the N-dimensional transformed and custom categorized financial data 203b in the N-dimensional financial format from the N-dimensional financial format view 203 for computing current metrics. As the user interacts with the interactive components, that is, the design paradigms and the visualizations such as mirror modeling 204a, user events 204b, market events 204c, etc., provided by the RTFM tool 204, the financial management platform dynamically adapts the computed current metrics to reflect changes caused by user interactions 207a with the interactive components and visualizations of the rendered financial data in the N-dimensional financial format on the GUI through the FMP user interface portal 207.

The real-time financial picture (RTFP) tool 205 of the financial management platform generates and renders dynamic real-time financial projections of the personal finances to the user based on the computed current metrics, the dynamically adapted current metrics, and one or more configurable parameters, for example, user events 204b, market events 204c, a product recommendation overlay, etc., and any combination thereof. There is a constant real-time feedback loop between the RTFM tool 204 and the RTFP tool 205. As the user interacts with the financial management platform through the FMP user interface portal 207, the RTFM tool 204 changes the current metrics in real time and the RTFP tool 205 consumes the updated current metrics and re-computes the financial projections in real time. The interactive components and the visualizations provided by the RTFM tool 204 can also be used on future projections 205a and on adjusted values computed by the RTFP tool 205. Through these interactive components and visualizations, the user can understand the impact of complex financial decisions in real time.

The RTFP tool 205 consumes the current metrics in real time as continuously computed by the RTFM tool 204 and projects the current metrics into the future for several years, for example, 25 years or longer using standardized financial techniques and econometric models. The future projections 205a, that is, the future dynamic real-time financial projections are computed through calculations that combine the computed current metrics and the adapted current metrics with market data and economic data. The RTFP tool 205 adjusts the generated dynamic real-time financial projections to account for changes in one or more of current and future tax rates and inflation rates 205c, foreign exchange rates, etc., and any combination thereof. The RTFP tool 205 generates a dynamic timeline graph 205b configured to render the computed current metrics, the dynamically adapted current metrics, and the generated dynamic real-time financial projections on the GUI.

The financial management platform (FMP) communicates with the web based business intelligence platform and provides real time access to FMP data, that is, financial information comprising the aggregated and categorized financial data, the computed current metrics, the dynamically adapted current metrics, results of the user interactions 207a with the interactive components and the visualizations of the rendered financial data in the N-dimensional financial format, and the generated dynamic real-time financial projections, to the business intelligence platform and to third parties, for example, financial institutions such as banks, credit unions, insurance agencies, etc., government agencies, regulatory bodies, etc., via the business intelligence platform. The business intelligence platform stores the FMP data in a real-time business intelligence (RTBI)/FMP data repository 210. The business intelligence platform also stores RTBI data, for example, profitability, sales numbers, interactions with the users of the financial management platform, etc., in the (RTBI)/FMP data repository 210. The business intelligence platform receives third party data, for example, from third party databases and repositories 208, web services, transaction systems, market data feeds, etc., and stores the third party data in the RTBI/FMP data repository 210. The third parties are provided with access to real-time financial data and as the financial data changes, the third parties can adapt their business decisions to the real-time changing financial data. The business intelligence platform performs data integration processes 209 to integrate the RTBI data, the FMP data, and the third party data.

The business intelligence platform provides a real-time business intelligence (RTBI) tool 211 that enables RTBI/RTFM portfolio overlay 211a, provides communication services 211b, and performs business analytics and reporting 211c. The RTBI tool 211 of the business intelligence platform is configured to receive one or more recommendations on one or more products, services, and investment ideas made by the third parties using real-time access of the financial information via one or more application programming interfaces (APIs) of the financial management platform. For example, the RTBI tool 211 stores the data associated with users of the financial management platform, and associated segmentation and analysis of the data in the RTBI data repository 210 and recommends products using the APIs to one or more users of the financial management platform via the business intelligence user interface portal 212. The users of the financial management platform to whom the recommendations are sent receive the product and/or idea specification automatically through the financial management platform 200a. The RTFM tool 204 consumes the product and/or idea specification and allows the user to overlay the current financial status with the product and/or idea specification to determine the current and projected impact to the user's financial status via the financial management platform. The user thus obtains the complete financial impact of transacting on the product and/or idea specification without engaging in any financial transaction through the product recommendation overlay. The RTBI tool 211 of the business intelligence platform facilitates real-time communication by providing communication services 211b between user devices and one or more financial institutions and within third parties via a network in multiple communication modes. For example, the RTBI tool 211 communicates with the financial management platform, the user devices, and the third parties via an email communication mode, a chat communication interface, video communication, etc.

The business intelligence platform supports data analysis across third parties that use the business intelligence platform. For example, third parties such as regulatory bodies comprising the consumer financial protection bureau (CFPB), the securities and exchange commission (SEC), etc., can perform a real-time oversight of the financial institutions that use the business intelligence platform. The regulatory bodies consume data in real time and monitor the financial institutions in real time via the business intelligence platform. In another example, regulatory bodies can monitor trends in product sales, demographics of users to whom sales have been made in real time to spot trends, potential overselling of products such as market bubbles to enable pro-active rather than reactive regulatory oversight, etc., via the business intelligence platform.

The business intelligence platform categorizes business intelligence data such as profitability, sales numbers, etc., and third party user interactions 212a acquired through the business intelligence user interface portal 212 into one or more categories across time based on predetermined criteria, for example, user demographics, type of investment ideas, the financial institutions associated with the financial user accounts 201, attributes of the financial data, etc., and any combination thereof, for determining and analyzing consumer trends. The business intelligence platform performs business analytics and reporting 211c to generate analytical reports based on changes in the aggregated and categorized financial data, market data, and economic data. The analytical reports can be consumed, for example, in non-electronic formats. The business intelligence platform can set the analytical reports to run on triggers allowing them to be generated automatically based on changes to one or more of the aggregated and categorized financial data, market data, economic data, etc. The business intelligence platform generates analytical reports for hard copy consumption, and in electronic formats, for example, the Microsoft Excel® worksheet of Microsoft Corporation, the Adobe® portable document format (PDF), etc.

The functions of the business intelligence platform are performed on a real-time basis as user decision parameters change, as users purchase and/or sell financial products, as financial user accounts 201 change, as market data changes, as economic data changes, etc. For example, the number of users of the financial management system that would fit the parameters for obtaining a mortgage could change intraday if the available best mortgage rates increased or decreased intraday. Similarly, if the user indicates an intent to purchase a home through the financial management system, through the user events 204b feature intraday, this would change the number of qualified users intraday. The business intelligence platform continuously updates changes in the user's financial data without requiring any manual intervention such as refresh or re-running processes by users at third party organizations.

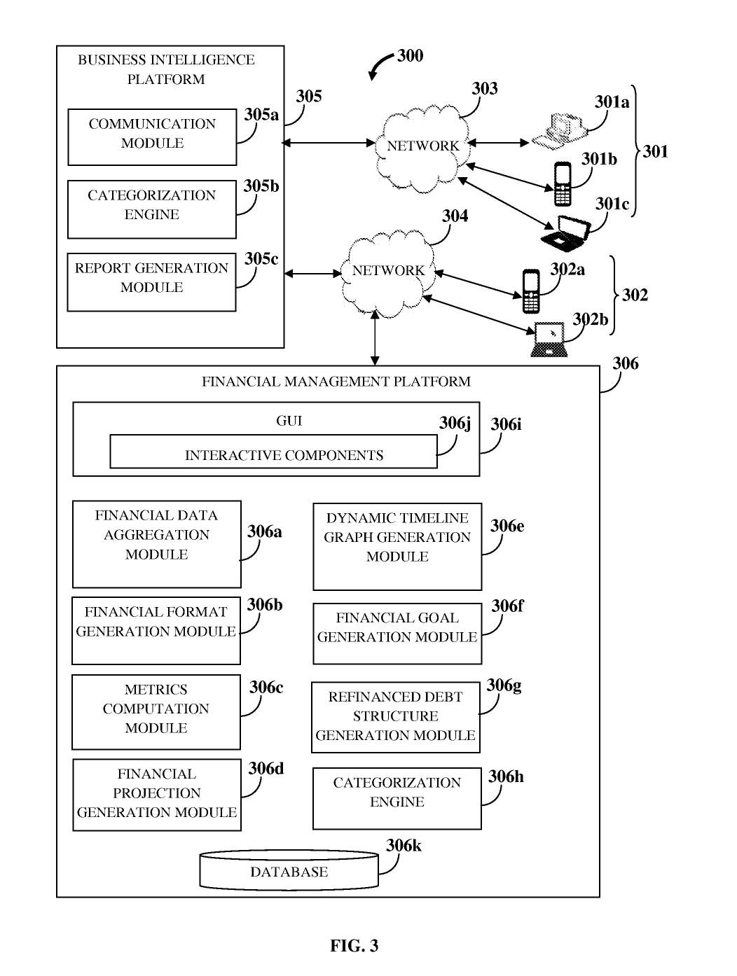

FIG. 3 exemplarily illustrates a computer implemented system 300 for managing financial data of a user in real time. The computer implemented system 300 disclosed herein, also referred to as a “financial management system”, comprises a financial management platform 306 accessible to one or more user devices 302, for example, a mobile phone 302a, a laptop 302b, etc., over a network 304. The network 304 is, for example, an internet, an intranet, a local area network, a wide area network, a communication network implementing Wi-Fi® of the Wireless Ethernet Compatibility Alliance, Inc., a cellular network, a mobile communication network, etc. The financial management platform 306 comprises at least one processor configured to execute modules 306a, 306b, 306c, 306d, 306e, 306f, 306g, 306h, 306i, 306j, 306k, etc., of the financial management platform 306. The financial management platform 306 further comprises a non-transitory computer readable storage medium communicatively coupled to the processor. The non-transitory computer readable storage medium is configured to store the modules 306a, 306b, 306c, 306d, 306e, 306f, 306g, 306h, 306i, 306j, 306k, etc., of the financial management platform 306. The financial management platform 306 comprises a graphical user interface (GUI) 306i, a financial data aggregation module 306a, a financial format generation module 306b, a metrics computation module 306c, a financial projection generation module 306d, a dynamic timeline graph generation module 306e, a financial goal generation module 306f, a refinanced debt structure generation module 306g, a categorization engine 306h, and a database 306k.

The GUI 306i of the financial management platform 306 comprises multiple interactive components 306j configured to acquire user interactions with the financial data. The financial data aggregation module 306a is configured to aggregate financial data from multiple financial user accounts. The categorization engine 306h of the financial management platform 306 is configured to categorize the aggregated financial data based on characteristics of the user's financial data. The database 306k stores the aggregated and categorized financial data. The database 306k is, for example, a structured query language (SQL) data store or a not only SQL (NoSQL) data store such as the Microsoft® SQL Server®, the Oracle® servers, the MySQL® database of MySQL AB Company, the mongoDB® of 10gen, Inc., the Neo4j graph database, the Cassandra database of the Apache Software Foundation, the HBase™ database of the Apache Software Foundation, etc.

The financial format generation module 306b is configured to generate an N-dimensional financial format configured to store and render the aggregated and categorized financial data in a transformed and modifiably categorized configuration on the GUI 306i. The N-dimensional financial format is configured to facilitate multiple real-time permutations of the aggregated and categorized financial data, and computations against the aggregated and categorized financial data. In an embodiment, the financial format generation module 306b is configured to acquire user inputs via the GUI 306i. The financial format generation module 306b is configured to overlay the acquired user inputs on the rendered financial data in the N-dimensional financial format to configure the financial projection generation module 306d to perform a prospective analysis of financial decisions and determine current financial status and future financial status of the user.

The metrics computation module 306c is configured to compute current metrics using the aggregated and categorized financial data stored in the N-dimensional financial format. Furthermore, the metrics computation module 306c is configured to dynamically adapt the computed current metrics in real time to reflect changes caused by the user interactions with one or more of the interactive components 306j and visualizations of the rendered financial data in the N-dimensional financial format on the GUI 306i. For example, the metrics computation module 306c assimilates and merges the results of user interactions using proprietary data structures and calculations to arrive at a single cohesive set of merged current metrics. The financial projection generation module 306d is configured to generate dynamic real-time financial projections based on the computed current metrics, the dynamically adapted current metrics, and one or more configurable parameters, for example, user events, market events, a product recommendation overlay, etc., and any combination thereof. Furthermore, the financial projection generation module 306d is configured to adjust the generated dynamic real-time financial projections to account for changes in one or more of current tax rates, future tax rates, inflation rates, foreign exchange rates, etc., and any combination thereof. Furthermore, the financial projection generation module 306d is configured to perform a comparative analysis of user events collectively dependent on each other to determine and display impact of one of the user events on another one or more of the user events on the GUI 306i.

The dynamic timeline graph generation module 306e is configured to generate a dynamic timeline graph configured to render the computed current metrics, the dynamically adapted current metrics, and the generated dynamic real-time financial projections on the GUI 306i. Furthermore, the dynamic timeline graph is configured to support direct real-time user interactions with the computed current metrics, the dynamically adapted current metrics, and the generated dynamic real-time financial projections on the GUI 306i.

The financial goal generation module 306f is configured to generate one or more financial goals as a result of the user interactions through one or more of the interactive components 306j and the visualizations of the rendered financial data in the N-dimensional financial format. The financial goal generation module 306f is further configured to collectively prioritize, manage, and track each of the generated financial goals against the financial user accounts. The refinanced debt structure generation module 306g is configured to generate an optimized refinanced debt structure, for example, based on one or more of loan information provided by one or more financial institutions, a user's existing debt structure, a user's liquid assets, etc. The categorization engine 306h of the financial management platform 306 is configured to categorize transaction data of the financial user accounts extracted from the aggregated and categorized financial data into spend categories. The financial projection generation module 306d is configured to acquire boundary conditions on spending for each of the spend categories to generate a budget, and facilitate tracking of the generated budget against subsequent spending.

The computer implemented system 300 disclosed herein further comprises a business intelligence platform 305 integrated with the financial management platform 306 directly or via a network 304. In an embodiment, the business intelligence platform 305 and the financial management platform 306 are configured to operate in a cloud computing environment. The business intelligence platform 305 comprises at least one processor configured to execute modules 305a, 305b, and 305c of the business intelligence platform 305. The business intelligence platform 305 is accessible by one or more multiple third party computing devices 301, for example, 301a, 301b, and 301c via a network 303, for example, the internet, a mobile communication network, etc. The financial management platform 306 is configured to provide real-time access of financial information comprising the aggregated and categorized financial data, the computed current metrics, the adapted current metrics, results of the user interactions with the interactive components 306j and the visualizations of the rendered financial data in the N-dimensional financial format, and the generated dynamic real-time financial projections, to the business intelligence platform 305 and to the third party computing devices 301 via the business intelligence platform 305 for performing data analysis and marketing segmentation analysis, adapting business decisions in real time, monitoring financial institutions associated with the financial user accounts, etc.

The business intelligence platform 305 further comprises a non-transitory computer readable storage medium communicatively coupled to the processor. The non-transitory computer readable storage medium is configured to store the modules 305a, 305b, and 305c of the business intelligence platform 305. The business intelligence platform 305 comprises a communication module 305a, a categorization engine 305b, and a report generation module 305c. The communication module 305a is configured to receive one or more recommendations on one or more products, services, and investment ideas made by one or more third parties using the real-time access of the financial information, via one or more application programming interfaces of the financial management platform 306. The financial management platform 306, in communication with the business intelligence platform 305, is configured to transmit the received recommendations to one or more user devices 301 via the network 304. The categorization engine 305b of the business intelligence platform 305 is configured to categorize business intelligence data and user interactions with the third parties into one or more categories across time based on predetermined criteria. The predetermined criteria comprise, for example, one or more of user demographics, type of investment ideas, the financial institutions associated with the financial user accounts, attributes of the financial data, etc., and any combination thereof, for determining and analyzing consumer trends. The report generation module 305c is configured to generate analytical reports based on changes in the aggregated and categorized financial data, market data, and economic data.

The computer implemented method and system 300 disclosed herein provides a web browser based access to the financial management platform 306, enhanced designs for interfaces, for example, the FMP user interface portal 207 exemplarily illustrated in FIG. 2, the GUI 306i, etc., of the financial management platform 306, browser compatibility with web browsers, for example, Internet Explorer® (IE) of Microsoft Corporation, Mozilla® of Mozilla Foundation Corporation, Chrome of Google, Inc., Safari® of Apple, Inc., etc., and smart navigation tabs on the interfaces, for example, the FMP user interface portal 207 of the financial management platform 306.

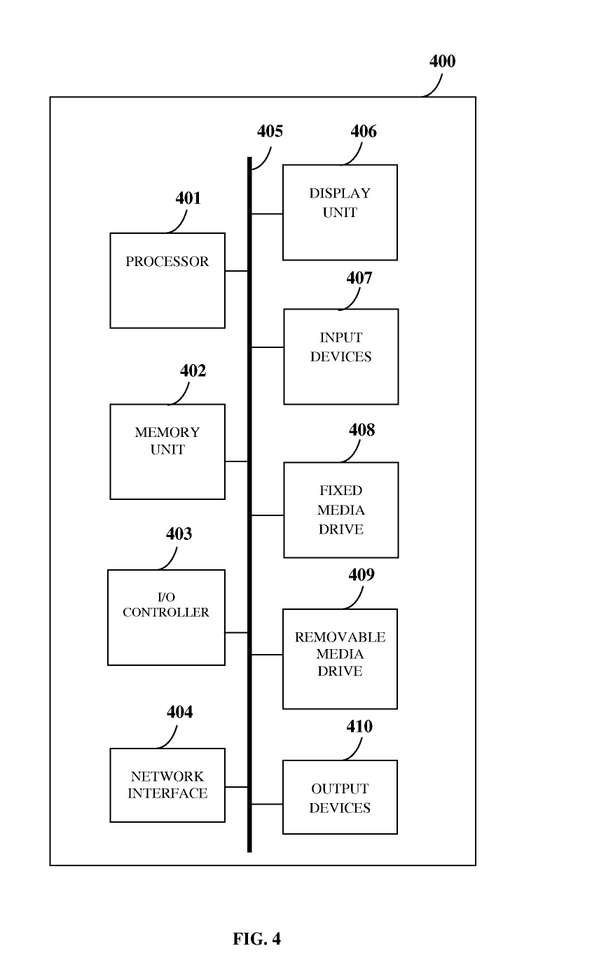

FIG. 4 exemplarily illustrates the architecture of a computer system 400 employed by the financial management system 300, exemplarily illustrated in FIG. 3, for managing financial data of a user in real time. The financial management platform 306 and the business intelligence platform 305 of the financial management system 300 employ the architecture of the computer system 400 exemplarily illustrated in FIG. 4. The computer system 400 comprises, for example, a processor 401, a memory unit 402 for storing programs and data, an input/output (I/O) controller 403, a network interface 404, a data bus 405, a display unit 406, input devices 407, a fixed media drive 408, a removable media drive 409 for receiving removable media, output devices 410, etc.

The processor 401 is an electronic circuit that executes computer programs. The memory unit 402 stores programs, applications, and data. For example, the financial data aggregation module 306a, the financial format generation module 306b, the metrics computation module 306c, the financial projection generation module 306d, the dynamic timeline graph generation module 306e, the financial goal generation module 306f, the refinanced debt structure generation module 306g, and the categorization engine 306h of the financial management platform 306, exemplarily illustrated in FIG. 3, are stored in the memory unit 402 of the computer system 400 of the financial management platform 306. The communication module 305a, the categorization engine 305b, and the report generation module 305c of the business intelligence platform 305 are stored in the memory unit 402 of the computer system 400 of the business intelligence platform 305. The memory unit 402 is, for example, a random access memory (RAM) or another type of dynamic storage device that stores information and instructions for execution by the processor 401. The memory unit 402 also stores temporary variables and other intermediate information used during execution of instructions by the processor 401. The computer system 400 further comprises a read only memory (ROM) or another type of static storage device that stores static information and instructions for the processor 401.

The computer system 400 of the financial management system 300 communicates with other interacting devices, for example, the user devices 302, the third party computing devices 301, etc., through the network interface 404. The network interface 404 is, for example, a Bluetooth® interface, an infrared (IR) interface, an interface that implements Wi-Fi® of the Wireless Ethernet Compatibility Alliance, Inc., a universal serial bus (USB) interface, a local area network (LAN) interface, a wide area network (WAN) interface, etc. The I/O controller 403 controls input actions and output actions performed by the financial management system 300. The data bus 405 permits communication between the modules, for example, 306a, 306b, 306c, 306d, 306e, 306f, 306g, 306h, 306i, 306j, 306k, etc., of the financial management platform 306 and the modules 305a, 305b, and 305c of the business intelligence platform 305.

The display unit 406 displays, for example, the N-dimensional financial format view 203 comprising the aggregated and categorized financial data in the N-dimensional financial format exemplarily illustrated in FIG. 2, the dynamic timeline graph, etc., via the GUI 306i of the financial management platform 306. The display unit 406 displays, for example, icons, user interface elements such as text fields, menus, display interfaces, etc., for managing financial data in real time. The input devices 407 are used for inputting data, for example, a user input, into the computer system 400. The input devices 407 are, for example, a keyboard such as an alphanumeric keyboard, a joystick, a computer mouse, a touch pad, a light pen, a digital pen, a microphone, a digital camera, etc. The output devices 410 output the results of the actions computed by the financial management platform 306, for example, to the user devices 302, or the actions computed by the business intelligence platform 305 to the third party computing devices 301. For example, the financial management platform 306 notifies a user of the computed current metrics, dynamic real-time financial projections, the generated dynamic timeline graph, etc., through a pop-up window on the output device 410, such as a display unit 406. Computer applications and programs are used for operating the computer system 400. The programs are loaded onto the fixed media drive 408 and into the memory unit 402 of the computer system 400 via the removable media drive 409. In an embodiment, the computer applications and programs may be loaded directly via a network 304, for example, a Wi-Fi° network. Computer applications and programs are executed by double clicking a related icon displayed on the display unit 406 using one of the input devices 407.

The computer system 400 employs an operating system for performing multiple tasks. The operating system is responsible for management and coordination of activities and sharing of resources of the computer system 400. The operating system further manages security of the computer system 400, peripheral devices connected to the computer system 400, and network connections. The operating system employed on the computer system 400 recognizes, for example, inputs provided by an operator of the financial management platform 306 or the business intelligence platform 305 using one of the input devices 407, the output display, files, and directories stored locally on the fixed media drive 408, for example, a hard drive. The operating system on the computer system 400 executes different programs using the processor 401. The processor 401 of the financial management platform 306 retrieves instructions for executing the modules, for example, 306a, 306b, 306c, 306d, 306e, 306f, 306g, 306h, 306i, 306j, etc., of the financial management platform 306 from the memory unit 402. The processor 401 of the business intelligence platform 305 retrieves instructions for executing the modules, for example, 305a, 305b, and 305c of the business intelligence platform 305 from the memory unit 402. A program counter determines the location of the instructions in the memory unit 402. The program counter stores a number that identifies a current position in a program of each of the modules, for example, 306a, 306b, 306c, 306d, 306e, 306f, 306g, 306h, 306i, 306j, etc., of the financial management platform 306 and the modules, for example, 305a, 305b, and 305c of the business intelligence platform 305.

The instructions fetched by the processor 401 from the memory unit 402 after being processed are decoded. The instructions are placed in an instruction register in the processor 401. After processing and decoding, the processor 401 executes the instructions. For example, the financial data aggregation module 306a defines instructions for aggregating financial data from multiple financial user accounts. The categorization engine 306h of the financial management platform 306 defines instructions for categorizing the aggregated financial data based on characteristics of the user's financial data. The financial format generation module 306b defines instructions for generating an N-dimensional financial format configured to store and render the aggregated and categorized financial data in a transformed and modifiably categorized configuration on the GUI 306i. The metrics computation module 306c defines instructions for computing current metrics using the aggregated and categorized financial data stored in the N-dimensional financial format. Furthermore, the metrics computation module 306c defines instructions for dynamically adapting the computed current metrics in real time to reflect changes caused by user interactions with one or more of the interactive components 306j and visualizations of the rendered financial data in the N-dimensional financial format on the GUI 306i. For example, the metrics computation module 306c defines instructions for assimilating and merging the results of multiple user interactions using proprietary data structures and calculations to arrive at a single cohesive set of current metrics. The financial projection generation module 306d defines instructions for generating dynamic real-time financial projections based on the computed current metrics, the dynamically adapted current metrics, and one or more configurable parameters.

Furthermore, the financial projection generation module 306d defines instructions for adjusting the generated dynamic real-time financial projections to account for changes in one or more of current and future tax rates, inflation rates, foreign exchange rates, etc., and any combination thereof. The financial projection generation module 306d also defines instructions for performing a comparative analysis of user events collectively dependent on each other to determine and display impact of one of the user events on another one or more of the user events on the GUI 306i. The financial format generation module 306b also defines instructions for overlaying user inputs acquired via the GUI 306i on the rendered financial data in the N-dimensional financial format to configure the financial projection generation module 306d to perform a prospective analysis of financial decisions and determine current financial status and future financial status of the user.

The dynamic timeline graph generation module 306e defines instructions for generating a dynamic timeline graph configured to render the computed current metrics, the dynamically adapted current metrics, and the generated dynamic real-time financial projections on the GUI 306i. The financial goal generation module 306f defines instructions for generating one or more financial goals as a result of user interactions through one or more of the interactive components 306j and the visualizations of the rendered financial data in the N-dimensional financial format. The financial goal generation module 306f further defines instructions for collectively prioritizing, managing, and tracking each of the generated financial goals against the financial user accounts. The refinanced debt structure generation module 306g defines instructions for generating an optimized refinanced debt structure based on one or more of loan information provided by one or more financial institutions, a user's existing debt structure, a user's liquid assets, etc. The categorization engine 306h of the financial management platform 306 defines instructions for categorizing transaction data of the financial user accounts extracted from the aggregated and categorized financial data into spend categories. The financial projection generation module 306d defines instructions for acquiring boundary conditions on spending for each of the spend categories to generate a budget, and for facilitating tracking of the generated budget against subsequent spending.

The communication module 305a of the business intelligence platform 305 defines instructions for receiving one or more recommendations on one or more products, services, and investment ideas made by one or more third parties using real-time access of the financial information, via one or more application programming interfaces (APIs) of the financial management platform 306. The categorization engine 305b of the business intelligence platform 305 defines instructions for categorizing business intelligence data and user interactions with the third parties into one or more categories across time based on predetermined criteria comprising, for example, user demographics, type of investment ideas, the financial institutions associated with the financial user accounts, attributes of the financial data, etc., and any combination thereof, for determining and analyzing consumer trends. The report generation module 305c defines instructions for generating analytical reports based on changes in the aggregated and categorized financial data, market data, and economic data.

The processor 401 of the computer system 400 employed by the financial management platform 306 retrieves the instructions defined by the financial data aggregation module 306a, the financial format generation module 306b, the metrics computation module 306c, the financial projection generation module 306d, the dynamic timeline graph generation module 306e, the financial goal generation module 306f, the refinanced debt structure generation module 306g, and the categorization engine 306h, and executes the instructions. The processor 401 of the computer system 400 employed by the business intelligence platform 305 retrieves the instructions defined by the communication module 305a, the categorization engine 305b, and the report generation module 305c, and executes the instructions.

At the time of execution, the instructions stored in the instruction register are examined to determine the operations to be performed. The processor 401 then performs the specified operations. The operations comprise arithmetic operations and logic operations. The operating system performs multiple routines for performing a number of tasks required to assign the input devices 407, the output devices 410, and memory for execution of the modules, for example, 306a, 306b, 306c, 306d, 306e, 306f, 306g, 306h, 306i, 306j, etc., of the financial management platform 306, and the modules 305a, 305b, and 305c of the business intelligence platform 305. The tasks performed by the operating system comprise, for example, assigning memory to the modules, for example, 306a, 306b, 306c, 306d, 306e, 306f, 306g, 306h, 306i, 306j, etc., of the financial management platform 306, and the modules, for example, 305a, 305b, and 305c of the business intelligence platform 305, and data, moving data between the memory unit 402 and disk units, and handling input/output operations. The operating system performs the tasks on request by the operations and after performing the tasks, the operating system transfers the execution control back to the processor 401. The processor 401 continues the execution to obtain one or more outputs. The outputs of the execution of the modules 306a, 306b, 306c, 306d, 306e, 306f, 306g, 306h, 306i, 306j, etc., of the financial management platform 306, and the modules, for example, 305a, 305b, and 305c of the business intelligence platform 305 are, for example, displayed to the user or an operator on the display unit 406.

For purposes of illustration, the detailed description refers to the financial management platform 306 and the business intelligence platform 305 disclosed herein being run locally on the computer system 400; however the scope of the computer implemented method and system 300 disclosed herein is not limited to the financial management platform 306 and the business intelligence platform 305 being run locally on the computer system 400 via the operating system and the processor 401 but may be extended to run remotely over the network 304, for example, by employing a web browser and a remote server, a mobile phone, or other electronic devices.

Disclosed herein is also a computer program product comprising a non-transitory computer readable storage medium that stores computer program codes comprising instructions executable by at least one processor 401 of the computer system 400 for managing financial data in real time. The non-transitory computer readable storage medium is communicatively coupled to the processor 401. As used herein, the term “non-transitory computer readable storage medium” refers to all computer readable media, for example, non-volatile media such as optical disks or magnetic disks, volatile media such as a register memory, a processor cache, etc., and transmission media such as wires that constitute a system bus coupled to the processor 401, except for a transitory, propagating signal.

The computer program product disclosed herein comprises multiple computer program codes for managing financial data in real time. For example, the computer program product disclosed herein comprises a first computer program code for aggregating financial data from multiple financial user accounts; a second computer program code for categorizing the aggregated financial data based on characteristics of the financial data; a third computer program code for generating an N-dimensional financial format configured to store and render the aggregated and categorized financial data in a transformed and modifiably categorized configuration on the GUI 306i; a fourth computer program code for computing current metrics using the aggregated and categorized financial data stored in the N-dimensional financial format; a fifth computer program code for dynamically adapting the computed current metrics in real time to reflect changes caused by user interactions with one or more of the interactive components 306j and visualizations of the rendered financial data in the N-dimensional financial format on the GUI 306i; and a sixth computer program code for generating dynamic real-time financial projections based on the computed current metrics, the dynamically adapted current metrics, and one or more configurable parameters.

The computer program product disclosed herein further comprises a seventh computer program code for providing real-time access of financial information comprising the aggregated and categorized financial data, the computed current metrics, the dynamically adapted current metrics, results of the user interactions with one or more of the interactive components 306j and the visualizations of the rendered financial data in the N-dimensional financial format, and the generated dynamic real-time financial projections, to the business intelligence platform 305 and to one or more of multiple third parties via the business intelligence platform 305 for performing data analysis and market segmentation analysis, adapting business decisions in real time, monitoring financial institutions associated with the financial user accounts, etc. The computer program product disclosed herein further comprises additional computer program codes for performing additional steps that may be required and contemplated for managing financial data in real time. In an embodiment, a single piece of computer program code comprising computer executable instructions performs one or more steps of the computer implemented method disclosed herein for managing financial data in real time.

The computer program codes comprising the computer executable instructions are embodied on the non-transitory computer readable storage medium. The processor 401 of the computer system 400 retrieves these computer executable instructions and executes them. When the computer executable instructions are executed by the processor 401, the computer executable instructions cause the processor 401 to perform the computer implemented method steps for managing financial data in real time.

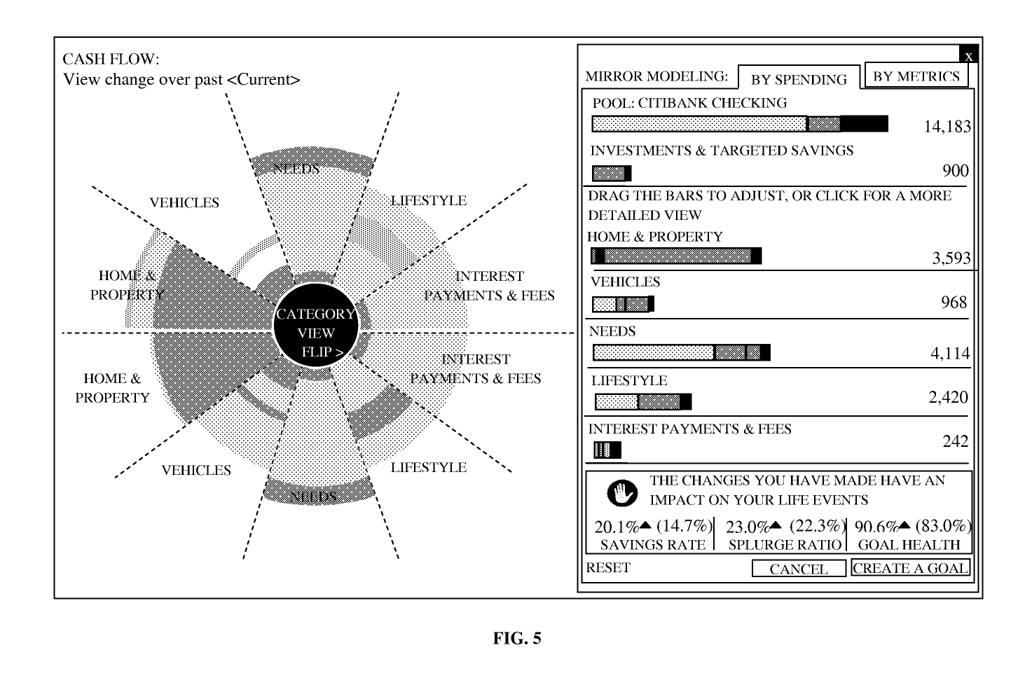

FIG. 5 exemplarily illustrates a graphical visualization of financial metrics data rendered by the financial management platform (FMP) 306 exemplarily illustrated in FIG. 3, based on mirror modeling. The financial management platform 306 provides the real-time financial modeling (RTFM) tool 204 and the real-time financial picture (RTFP) tool 205 as exemplarily illustrated in FIG. 2, for managing the financial data of the user. The minor modeling technique is employed by the financial management platform 306 to allow users to change their current financial picture or status by altering current metrics computed by the RTFM tool 204 to view the potential impact of the change to their future financial picture or status, and to provide the users with functionality to overlay the current financial data with user inputs to perform a “What if?” type of analysis on financial decisions without having to engage in transactions or modifications underlying the financial user accounts of the user to obtain the results. For example, the impact of a user's financial decision is projected several years into the future, for example, 25 years or longer to enable the user to understand “what happens today?” and also “what happens in the future?” The financial management platform 306 provides the visualization of the minor model in the form of, for example, a table, a pie chart, a tree map such as standard or complex tessellations such as Voronoi or other externally documented visual techniques on the graphical user interface (GUI) 306i. As the user alters the current metrics, the RTFM tool 204 and the RTFP tool 205 automatically in real time adjust the current metrics changed by the user, associated metrics that consume the changed metrics as input, and the future projections of these metrics. As a result, the changes result in impacting the user's financial picture which are visually rendered and represented on the GUI 306i.

In mirror modeling, the current metrics as computed by the RTFM tool 204 and/or future projections of the current metrics as computed by the RTFP tool 205 are visualized, for example, as a set of blades in a radial circular pattern. The metrics visualized in a circular chart visualization exemplarily illustrated in FIG. 5 correspond, for example, to a current value or a future value of an asset, a liability, an equity, gains or losses, expenses, savings, spending, etc., broken down into categories such as home and property, vehicles, interest payments and fees, lifestyle expenses, miscellaneous expenses, etc. The length of each blade in the circular chart represents a single metric that is further broken down into subcomponents used in computing the overall metric. For example, a blade may represent a total asset value, while subsections of the blade represent a liability amount, an equity amount, a change in liability, and a change in equity. The financial management platform 306 calculates the overall length of each blade in proportion to the value of the metric being measured, for example, the total asset value, and scales the overall length of each blade such that the relative size differential between any one category blade and related category blades is maintained.

Each blade represents a single current metric or several current metrics in aggregate. The blades may undergo a nonlinear transformation to achieve the visualization exemplarily illustrated in FIG. 5. As exemplarily illustrated in FIG. 5, the blade representation is inverted along a diameter axis. Each current metric represented on the blade is tied to a slider on the FMP user interface portal 207 exemplarily illustrated in FIG. 2, which provides the current level of the metric or aggregate metrics. As the user alters the slider, the RTFM tool 204 adjusts the computation of the associated current metrics automatically in real time. Concurrently, the RTFP tool 205 adjusts the future projections and impacts of the changes to the current metrics. Visually, the financial management platform 306 adjusts the inverted representation of the metric or aggregate metrics to show the intended changes. The financial management platform 306 completes the changes and visualizations in real time and in an on-demand manner.

In an embodiment, the financial management platform 306 displays a flip view on the FMP user interface portal 207 that enables the set of two-dimensional financial data to be flipped on its axis, for example, by a click of a button, where the rows become columns and the columns become rows. With respect to minor modeling exemplarily illustrated in FIG. 5, the financial management platform 306 interchanges the blades and breakup slices of the spokes in the flip view. In another embodiment, the RTFM tool 204 computes second order derived calculations using the first order current metrics and/or the projected metrics as input. In minor modeling, as the user moves the slider on the FMP user interface portal 207, the second order derived metrics change on demand to reflect new values. In reverse modeling, the RTFM tool 204 sets the second order derived calculation to a particular level and reverse engineers the first order current metrics and/or the projected metrics to arrive at the second order derived calculation set point.

In another embodiment, the financial management platform 306 provides the minor model and the results of the minor modeling as savable entities. The savable entities may then be managed and tracked by goal management 206b of the application layer 206 exemplarily illustrated in FIG. 2. In an embodiment, the graphical visualization of financial metrics data rendered by the financial management platform 306 is based on state based minor modeling. The changes made by the user to the current financial picture are a separate state based entity used by the financial management system 300. The changes are saved in repositories, for example, an aggregate and persisted database 306k in the financial management platform 306, ensuring that even if the user logs out and logs back in, the changes are saved and not discarded. The changes contained within the mirror model may be enabled or disabled as an entire entity. If the user chooses to view the current financial picture and the future financial picture without the minor model overlay, the user need not have to delete the minor model from the financial management platform 306. The enabling and disabling functionalities of the minor model are implemented as a toggle on and toggle off feature in the financial management platform 306.

Examples of the mirror model used by the financial management platform 306 to overlay the user inputs on the rendered financial data to perform a prospective analysis to compute the impact on the user's current financial status and future financial status comprise a spending based mirror model, an assets/liabilities minor model, an investment based minor model, an income based mirror model, etc. In the spending based mirror model, the financial management platform 306 sets new spending overlays, for example, budgets based on total spending, within categories and/or segments of total spending, budgets based on an increase or a decrease in a savings rate of a user, budgets based on an increase or a decrease of recurring monthly payments such as mortgages, rent, credit cards, etc., budgets based on an increase or a decrease in non-recurring payments such as purchases made at irregular frequencies, etc. In the assets/liabilities mirror model, the financial management platform 306 models overlays, for example, lump sum prepayments of liabilities, allocation between asset classes such as between cash and investments, rebalance based on liquidity, rebalance based on leverage, etc. In the investment based minor model, the financial management platform 306 models overlays, for example, changing asset allocation among assets classes such as equities, commodities, etc., sub asset classes such as equities large cap, equities small cap, etc., risk categorizations, liquidity categorizations, etc. In the income based mirror model, the financial management platform 306 models overlays as a change to current income or future expected income. In an embodiment, the financial management platform 306 sets and deploys mirror modeling at a future point in time, thereby affecting subsequent future metrics without changing the current metrics.

In another embodiment, the user's financial decisions are modeled as user events. Examples of the user events comprise items such as purchasing a home, having a child, or retirement. Each user event has associated properties which are computed using the current metrics and/or the projected metrics at the time at which the user event becomes active for the user. The addition, deletion, or amendment of a “user event” by the user also impacts the future projection of metrics as computed by the RTFP tool 205. This, in turn, may affect other events via their properties, as well as other processes consuming these future projections. The user financial decision modeling based on the user events comprises performing a comparative analysis of the user events collectively dependent on each other to calculate and display impact of one of the user events on another one or more of the user events on the GUI 306i. In an embodiment, the financial management platform 306 allows user events to be prioritized, for example, by a weighting mechanism set by the user, sequentially in time to determine trade-offs and feasibility across the user events for the user's current financial status and future financial status, etc.

In modeling based on market events, also referred to as “market scenarios”, the financial management platform 306 represents past broad market events as a set of variables and functions which are then applied to current metrics by the RTFM tool 204, while the future impact is further modeled by the RTFP tool 205. Conventionally, this type of analysis is performed for trading portfolios at large financial institutions to assess risk on the portfolios. The financial management platform 306 applies this analysis to a personal finance framework to show the impact of broad market events to an individual's financial picture. In an embodiment, the financial management platform 306 supports combining market scenarios beginning at the same time or beginning at different points in time.

In modeling based on a product recommendation overlay, users can overlay financial products specifications and/or financial idea specifications to their current financial status to determine the current and projected impact to the user's financial status via the financial management platform 306. The user thus obtains the complete financial impact of transacting on the product and/or idea specification without engaging in any financial transaction through the product recommendation overlay.

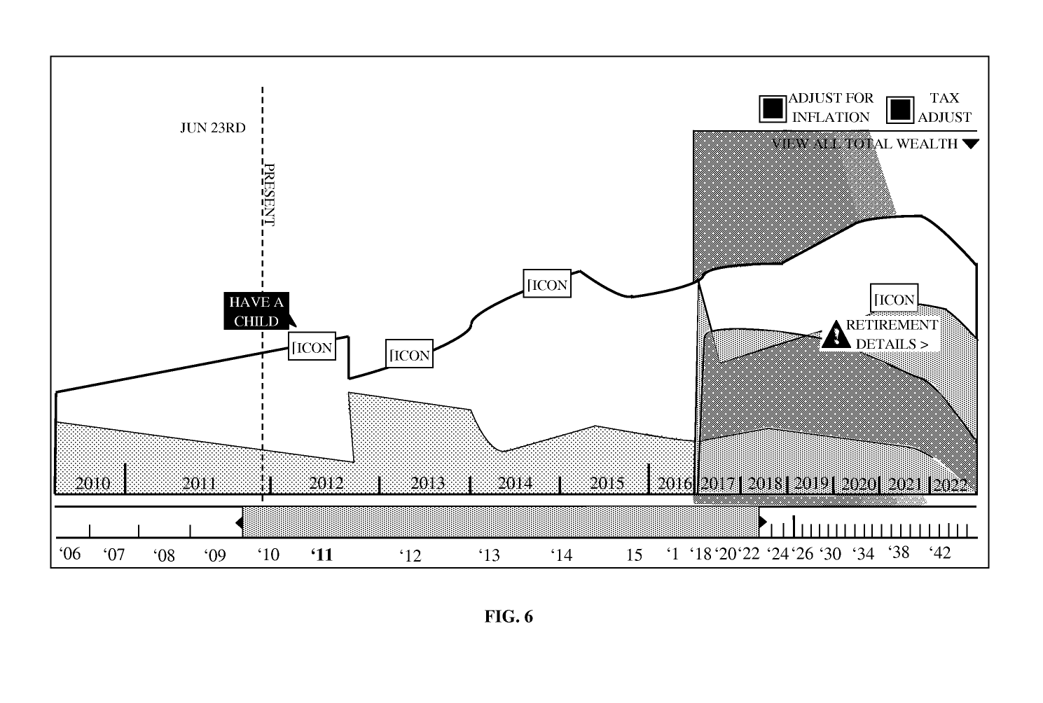

FIG. 6 exemplarily illustrates a dynamic timeline graph generated by the financial management platform (FMP) 306 exemplarily illustrated in FIG. 3, showing past, present, and projected personal financial metrics over time. The dynamic timeline graph is a graphical visualization generated by the real-time financial picture (RTFP) tool 205 exemplarily illustrated in FIG. 2. The dynamic timeline graph is, for example, a two-dimensional graph that measures the level of past, current, and projected future metrics versus time. Compared to a regular graph where data is received and plotted, the dynamic timeline graph generated by the financial management platform 306 is interactive. The RTFM tool 204 and the RTFP tool 205, exemplarily illustrated in FIG. 2, compute the current metrics and future financial projections of the current metrics respectively, and adjust these metrics as the user interacts with the financial management platform 306 automatically in real time, for example, through mirror modeling, user events, market scenarios, and a product recommendation overlay, displayed on the FMP user interface portal 207.

As the RTFM tool 204 and the RTFP tool 205 adjust the values of the current metrics and future financial projections respectively, in real time, the dynamic timeline graph also adjusts the display on the FMP user interface portal 207 automatically in real time. The curves on the dynamic timeline graph represent any computable metric, for example, current and future projections of total asset values, liability values, income, spending, etc. The different shaded or overlapping areas on the dynamic timeline graph represent, for example, “before” effects and “after” effects of dynamic adjustments made by configurable parameters, for example, minor modeling, user events, market scenarios, a product recommendation overlay, such that the user may quickly identify the impact of the change. The icons on the dynamic timeline graph represent the different user events on the timeline at a point in time when a user event occurs. On the graphical user interface (GUI) 306i, each user event is represented by a graphical icon in addition to descriptive text and input fields the user specifies for the event.

In an embodiment, any current metric and/or projected metric at a future date can be further adjusted by an inflation rate and/or a tax rate as applicable, or by any other such predefined rates, and shown on the dynamic timeline graph exemplarily illustrated in FIG. 6. The dynamic timeline graph has the ability to show timeline metrics on a raw basis as well as an inflation adjusted and/or tax adjusted basis in real time, for example, with the click of a checkbox as exemplarily illustrated in FIG. 6, to normalize the effect of these factors on assets, liabilities, income, and spending. In an embodiment, the financial management platform 306 also supports adjustments such as currency conversions for computing the metrics and the visualizations.

In the application layer 206 exemplarily illustrated in FIG. 2, the financial management platform 306 enhances budgeting and spending analyses 206a, goal management 206b, and debt optimization 206c. Generally, budgeting and spending analyses 206a involve grouping transaction data from the financial user accounts such as credit card accounts and debit card accounts into broad categories. The user can then set a budget by establishing limits on spending per category and can track the set budget against future spending. The financial management platform 306 enhances the budgeting and spending analyses 206a, for example, by implementing a concept of a pool, budgeting and tradeoffs, and custom categorizations. The financial management platform 306 generates a pool that enables the user to track expenses across a set of financial entities through which all spending occurs. The aggregation of cash inflows into these financial entities defines the total pool amount. The financial management platform 306 further decomposes the total amount of the pool into funds used for spending, funds used for savings, and funds that are leftover as free cash. By adjusting the total pool amount or the amounts of the subcomponents, the user can holistically manage spending and overall cash flow. For budgeting and tradeoffs, the financial management platform 306 performs budgeting in relation to the pool. A reduction in spending, either overall or in a specific category, adds to the pool, while an increase in spending, either overall or in a specific category, removes from the pool. The financial management platform 306 defines boundary conditions to determine how the pool and the individual spending categories interact. Therefore, the financial management platform 306 accomplishes budgeting as a comprehensive set of spending targets limited by overall cash flow funds as opposed to spending targets driven solely by underlying transaction data.

In addition to categorization of transactions into broad spending categories, for example, groceries, entertainment, etc., the financial management platform 306 further categorizes the spending, for example, into liability spending, baseline spending, and excess spending. Liability spending refers to spending based on interest and borrowing. Baseline spending and excess spending refer to spending based on calculations of the remaining spending within the category using statistical measures, for example, a mean, a standard deviation, and/or a third lowest level of expense.

Most personal financial management (PFM) systems manage goals by assigning a one-to-one mapping between a single financial goal and a single financial user account. Generally, a financial goal is created in the PFM system by a user specifying a monetary amount towards which he/she wants to save. Once this sum is entered by the user, the PFM system requires the user to open a new savings account, for example, with a financial institution to deposit funds to use for the financial goal. The progress for the financial goal is then tracked by tracking the required financial goal amount against the balance in the underlying financial user account. The financial management platform 306 disclosed herein does not use a one-to-one mapping between a financial goal and a financial user account. Through enhanced goal management 206b in the application layer 206, financial goals may be created in the financial management platform 306 through a multitude of configurable parameters, for example, user events, market events, minor modeling, a product recommendation overlay, etc., as well as a one-off user input of monetary sums. The financial management platform 306 then assigns priorities to the financial goals based on a user preference or in a time sequential manner. For example, the financial management platform 306 assigns priorities based on an importance of the financial goal, an occurrence of the financial goal, etc. The financial management platform 306 computes the priorities, for example, using a statistical technique that weighs the time remaining to accomplish the financial goal as well as the impact that the accomplishment of the financial goal would have on the associated current metrics and/or the projected metrics generated by the RTFM tool 204 and the RTFP tool 205 respectively. Using this prioritization, the financial management platform 306 manages and tracks the financial goals against a pool of financial user accounts specified by the user using a fund allocation methodology. In this manner, the financial management platform 306 maps multiple financial goals to multiple financial user accounts as opposed to the conventional one-to-one mapping.

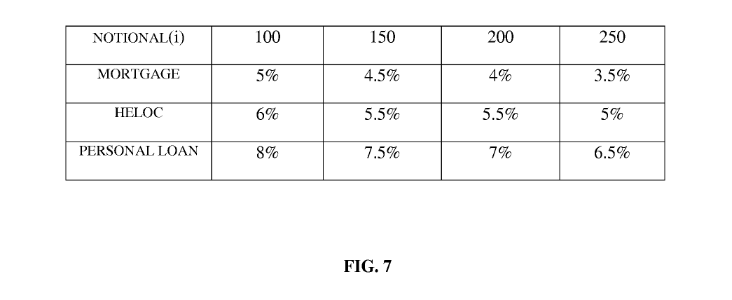

Furthermore, for an existing debt structure of a user with debts, for example, a mortgage, a student loan, a personal loan, a home equity line of credit (HELOC), a credit card debt, unpaid personal bills, etc., the debt optimization 206c feature of the financial management platform 306 finds a methodology where the debt of the user can be refinanced by substituting the user's current debt structure with a cheaper globally optimal debt structure such that the effective annual interest rate paid by the user is minimized to the lowest possible value, given the current interest rates on debt instruments. The financial management platform 306 solves a linear program optimization problem, per notional amount that the user can potentially refinance in order to determine an optimal debt structure for the user. The inputs to the optimization problem include a financial institution loan table exemplarily illustrated in FIG. 7, a user's existing debt structure, and a user's liquid assets.

The financial institution sends multiple financial institution loan tables, for example, a loan table for users with a good credit rating, a loan table for users with a poor credit rating, etc., to the financial management platform 306 directly or via the business intelligence platform 305. The user's existing debt structure is obtained from the financial user accounts. The user's liquid assets refer to the amount the user can opt to use to make a payment towards the user's debt in addition to refinancing. The amount of available liquid assets is obtained from computations performed by the financial management platform 306.

The generation of the optimized refinanced debt structure by the financial management platform 306 comprises generating an interest rate structure using user configurable filters on the loan information sourced from the financial institution loan tables. The user configurable filters are computations performed by the financial management platform 306 and comprise credit standing of the user, mortgage eligibility based on a home equity, a home equity line of credit (HELOC) eligibility based on home equity, a personal loan eligibility based on income and/or net asset, maximum personal loan allowed, maximum HELOC loan allowed, maximum mortgage allowed, maximum notional of the existing user's debt, etc. The generation of the optimized refinanced debt structure further comprises adjusting the annual percentage rate (APR) in the financial institution loan tables to include adjustments for tax deductibility using the user's federal income tax rate, and origination fees based on market data and economic data. The financial management platform 306 computes the optimized refinanced debt structure using the user-based interest rate structure, for each possible total notional starting with the least amount the user can refinance up to the maximum amount that can be refinanced by the user using an integer program optimization technique.

For each possible total notional refinanceable by the user, that is represented as “User_Notional_Totalⱼ” an integer program with the following framework is solved:

Variables used:

W_{mortgage (i)}=decision variable for mortgage of notional i

W_{personal loanl(i)}=decision variable for personal loan of notional i

W_{heloc(i)}=decision variable for HELOC of notional i

where “i” is associated with a notional amount provided in the financial institution loan table. For purposes of illustration, the variables above refer to a mortgage, a personal loan, and HELOCs; however the scope of the computer implemented method and system 300 disclosed herein is not limited to variables for a mortgage, a personal loan, and HELOCs but may be extended to include other types of debt instruments.

The objective function is to minimize:

Σ_{∀i}Mortgage Amountᵢ*Mortgage Interestᵢ*W_{mortgage(i)}+Personal Loan Amountᵢ*Personal Loan Interestᵢ*W_{personal loanl(i)}+Heloc Amountᵢ*Heloc Loan Interestᵢ*W_{heloc(i)}

where “i” is associated with a notional amount in the financial institution loan table, subject to the following constraints:

Σ_{∀i}

Σ_{∀i}W_{mortgage(i)}<=1

W_{personal loan(i))}<=1

Σ_{∀i}W_{heloc(i)}<=1

Σ_{∀i} Notionalᵢ*(W_{mortgage(i)}+W_{personal loan(i)}+W_{heloc(i)})=User_Notional_Totalⱼ

Σ_{∀i} Notionalᵢ*(W_{mortgage(i)}+W_{heloc(i))}=maximum_user_home_equity.

Once the optimal debt structure per possible user notional is found, the financial management platform 306 sets the solution that yields the lowest effective interest rate for the user as the optimal debt optimization 206c solution for the user. The optimization technique ensures measure of effective rates. That is, the interest rates used for each product and notional combination are adjusted for tax deductions and closing costs. Tax adjustments are made using the user's individual income tax rate. The closing costs are estimated using calculations that are a function of the notional amount being refinanced and market data associated with prevailing costs. The optimization technique also enables the users to use existing liquid assets such as cash and investments to make a payment towards the debt in addition to refinancing when computing the linear program. If the user elects to use existing assets to make a payment towards the debt, this has the effect of changing the total possible user notionals “User_Total_Notionalⱼ” that the integer program is run for.

The optimization technique generates an optimized refinanced debt structure for the user across the financial institution loan tables since the integer program is setup to compare possible feasible solutions for the user. The optimization technique takes into account an effect of marginal rates as well as effective rates as possible feasible solutions are compared for the user. The optimization technique determines convex and concave regions in interest rates and does not assume any linear or upward sloping assumptions about the interest rate structure of debt products. Therefore, even in complex rate curves, the globally optimal solution is guaranteed for the user. The optimization technique delivering the optimized refinanced debt structure of the user is treated by the financial management platform 306 as an overlay, thereby allowing the user to understand both the current and future impact of optimizing debts to the user's financial decisions, the financial user accounts, etc.

FIG. 7 exemplarily illustrates a financial institution loan table sourced from financial institutions. The financial institution loan tables comprise, for example, data such as a raw mortgage, a home equity line of credit (HELOC), and a personal loan, in terms of an annual percentage rate (APR) across discretized notional amounts. The financial institution loan tables are obtained from various financial institutions, for example, banks, investment firms, credit unions, insurance agencies, brokerages, etc.

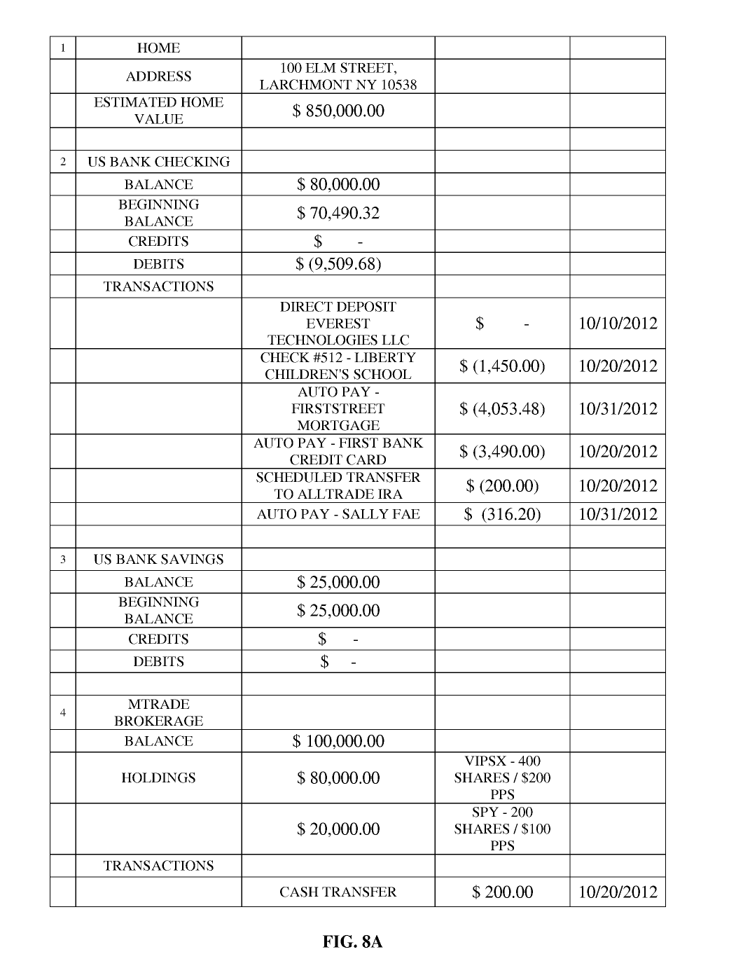

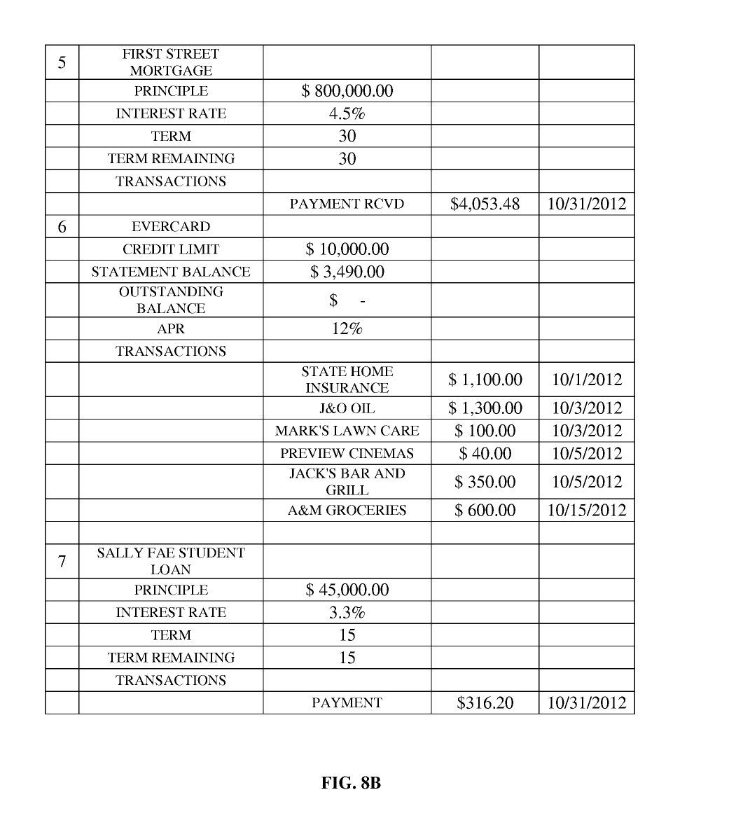

FIGS. 8A-8B exemplarily illustrate a table showing financial data aggregated from financial user accounts. The financial management platform 306, exemplarily illustrated in FIG. 3, manages the financial data associated with multiple financial user accounts. The financial management platform 306 automatically aggregates financial data from multiple financial user accounts, for example, a US bank checking account, a US bank savings account, a brokerage account, a credit card account, etc., as exemplarily illustrated in FIGS. 8A-8B. The financial data prior to aggregation is in a raw data format. The financial data of the user comprises financial account data, for example, bank account details of a US bank checking account, a US bank savings account, etc., investment account details of an MTrade Brokerage, mortgage details of a First Street Mortgage, loan account details such as Sally Fae's student loan details, real estate details, etc., as exemplarily illustrated in FIGS. 8A-8B. Furthermore, the financial information comprise transactions conducted by the user in the financial user accounts, balance associated with the financial user accounts, for example, a beginning balance, etc., an interest rate, for example, “3.3%”, etc. For example, transactions such as “Auto pay—First Street Mortgage” of “$4,053.48” on “Oct. 31, 2012”, “Auto pay—First Bank Credit Card” of “$3,490.00” on “Oct. 20, 2012”, “Scheduled Transfer to AllTrade IRA” of “$200.00” on “Oct. 20, 2012”, “Check #512—Liberty Children's School” of “$1,450.00” on “Oct. 20, 2012”, “State Home Insurance” of “$1,100.00” on “Oct. 1, 2012”, etc., exemplarily illustrated in FIGS. 8A-8B represent the transactions conducted by the user in the financial user accounts.

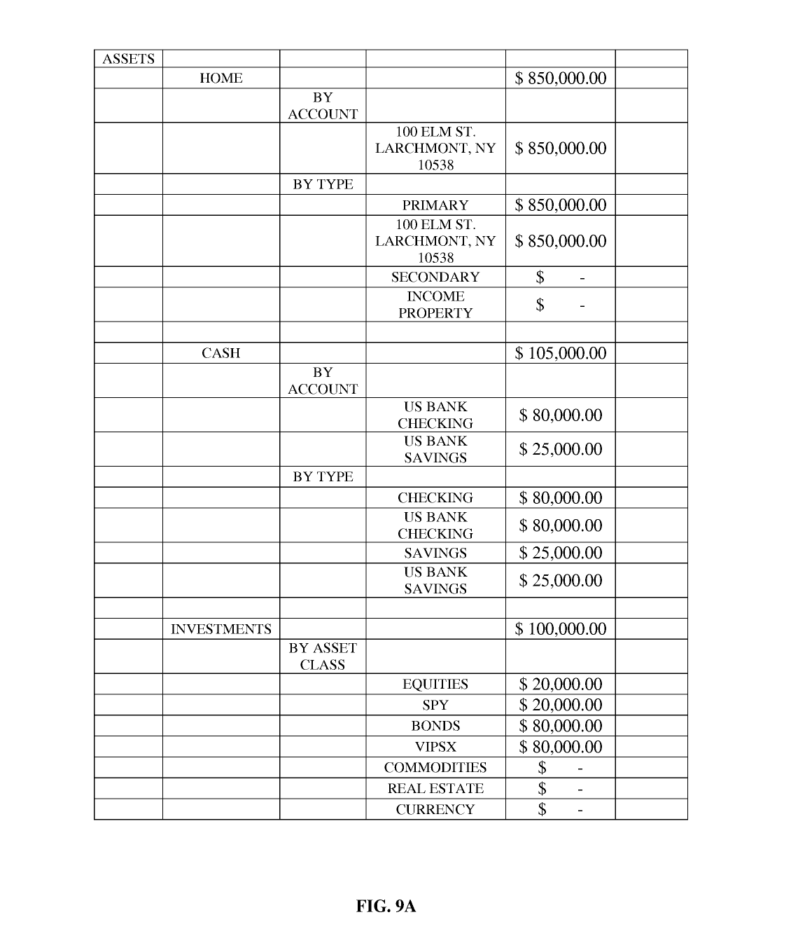

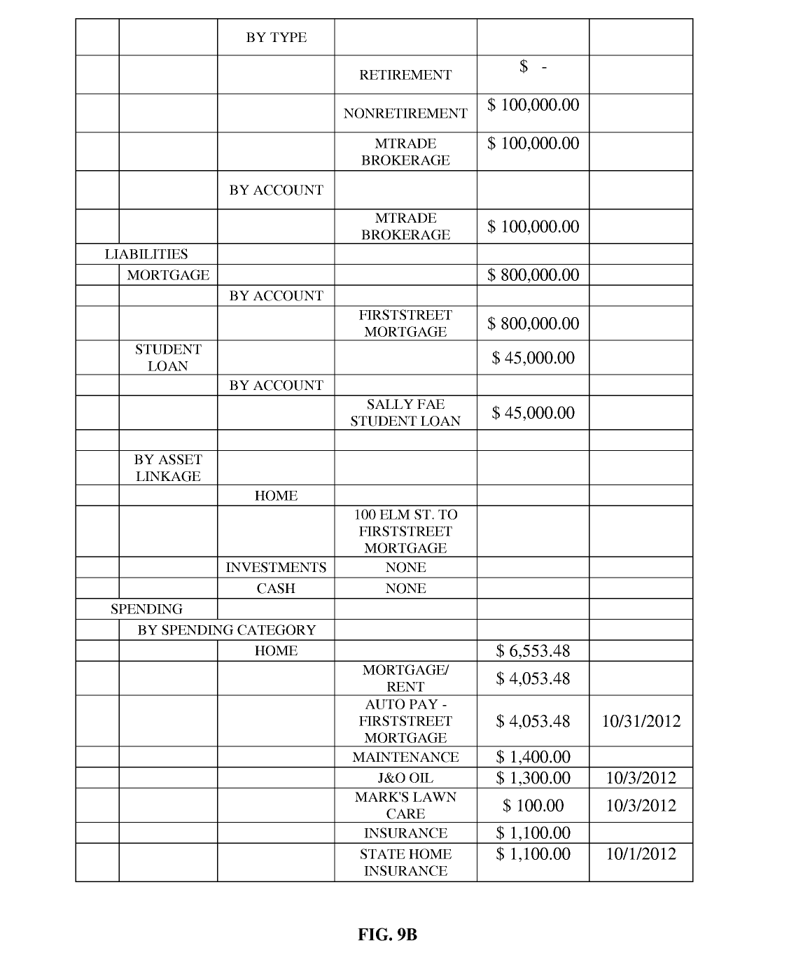

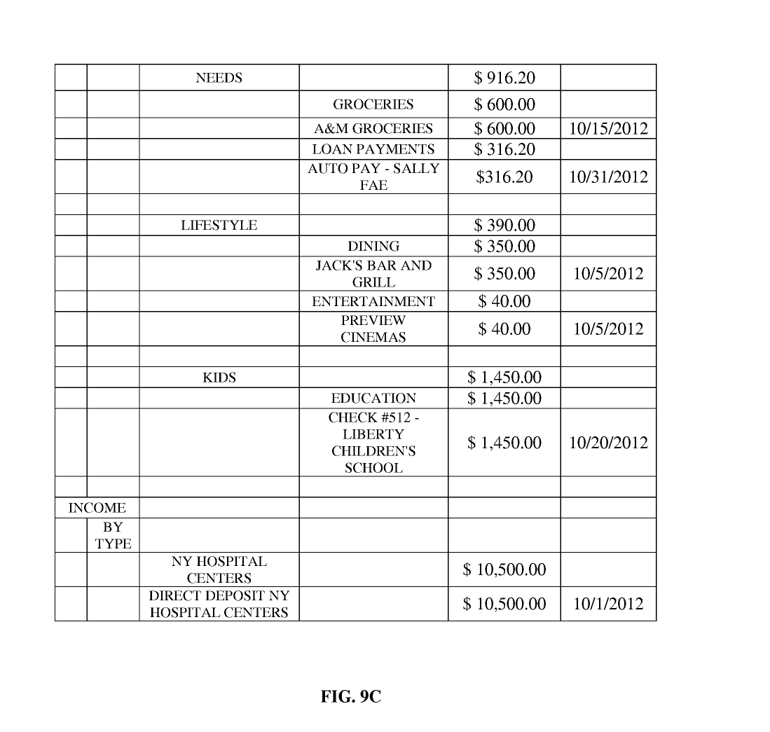

FIGS. 9A-9C exemplarily illustrate a table showing aggregated and categorized financial data stored in an N-dimensional financial format in a transformed and modifiably categorized configuration. The financial management platform 306, exemplarily illustrated in FIG. 3, implements the N-dimensional financial format programmatically as a multi-dimensional object structure in memory using data structures, for example, dictionary, hash table, and script oriented data structures such as JavaScript® objects. The financial management platform 306 segments the financial data, for example, an account balance into custom categorizations to enable quick data retrieval and computations along the segmented field. The financial management platform 306 generates the N-dimensional financial format programmatically using custom data translation and categorization methods. As exemplarily illustrated in FIGS. 9A-9C, the financial management platform 306 categorizes financial data of the user into categories, for example, assets, liabilities, spending, income, etc., and displays the account balance information for each of the categories on the graphical user interface (GUI) 306i of the financial management platform 306. The assets in the form of, for example, home, cash, investments, etc., are broken down into categories and listed, for example, “by account”, “by type”, “by asset class”, etc., on the GUI 306i. The liabilities in the form of, for example, a mortgage, a student loan, an asset linkage, etc., are broken down into categories and listed, for example, “by account”, “by home”, “by investments”, “by cash”, etc., on the GUI 306i. The spending in the form of, for example, spending categories are broken down into categories such as “home”, “needs”, “lifestyle”, “kids”, etc. The income in the form of income type is broken down into categories based on the source of the income, for example, “NY Hospital Centers”, etc. In an example, the user may list the financial data on the GUI 306i using the “by account” category and view the account balance of assets in the form of cash in a US bank checking account as “$80,000.00”.

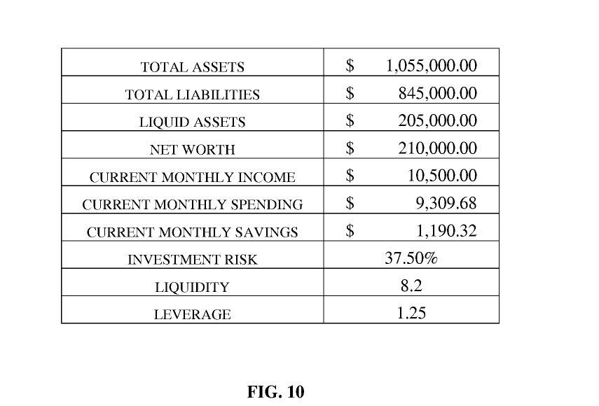

FIG. 10 exemplarily illustrates a table showing current metrics computed using aggregated and categorized financial data stored in an N-dimensional financial format. The RTFM tool 204, exemplarily illustrated in FIG. 2, of the financial management platform 306 exemplarily illustrated in FIG. 3, computes current metrics, for example, total assets, total liabilities, liquid assets, net worth, current monthly income, current monthly spending, current monthly savings, investment risk, liquidity, leverage, etc., using the user's financial data as exemplarily illustrated in FIG. 10. The current metrics are used to compute financial projections and adapted current metrics to reflect changes caused by user interactions. The current metrics are stored in the N-dimensional financial format.

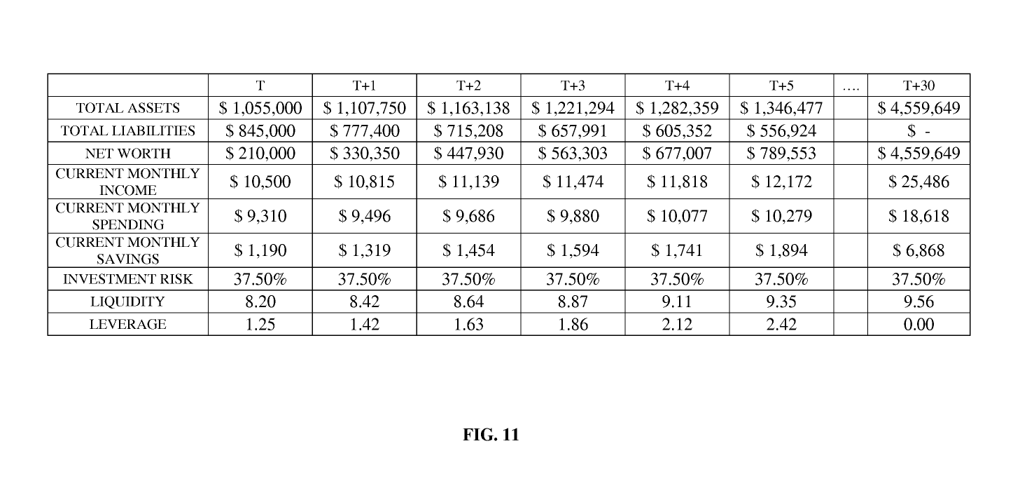

FIG. 11 exemplarily illustrates a table showing dynamic financial projections of the current metrics generated by the financial management platform 306 shown in FIG. 3. The RTFP tool 205, exemplarily illustrated in FIG. 2, of the financial management platform 306 computes dynamic real-time financial projections of the current metrics, for example, total assets, total liabilities, net worth, current monthly income, current monthly spending, current monthly savings, investment risk, liquidity, leverage, etc., for different time periods, for example, “T”, “T+1”, etc., using econometric techniques based on market data and economic data. In an example, the total assets at time instances “T”, “T+1”, “T+2”, “T+3”, “T+4”, “T+5”, and “T+30” are “$1,055,000”, “$1,107,750”, “$1,163,138”, “$1,221,294”, “$1,282,359”, “$1,346,477”, and “$4,559,649” respectively, as exemplarily illustrated in FIG. 11. The financial projections adapt in real time as the current metrics change.

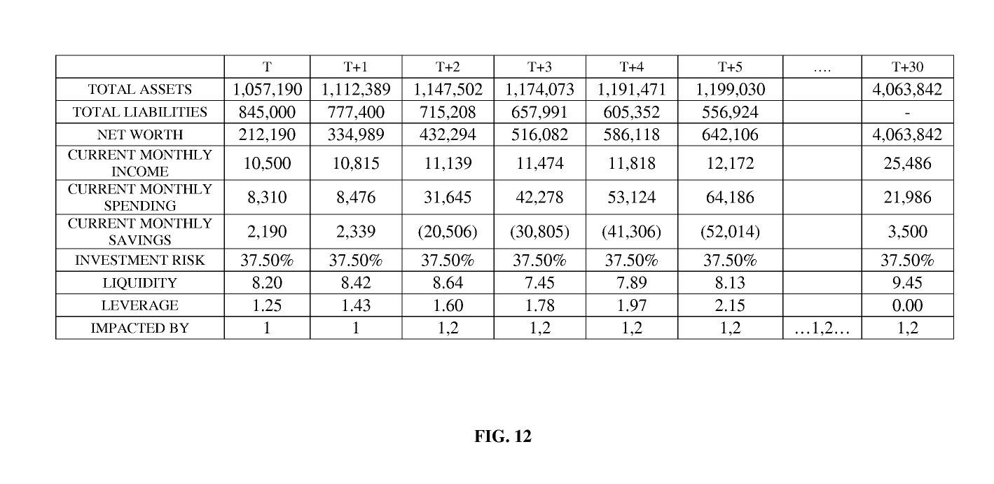

FIG. 12 exemplarily illustrates a table showing current metrics and financial projections of the current metrics dynamically adapted based on changes caused by user interactions with one or more interactive components 306j exemplarily illustrated in FIG. 3, visualizations, and configurable parameters. The configurable parameters comprise, for example, user events, market events, a product recommendation overlay, etc. A user interaction via minor modeling based on spending is exemplarily illustrated in FIG. 12. The RTFM tool 204 of the financial management platform 306, exemplarily illustrated in FIGS. 2-3, dynamically adapts the current metrics, for example, total assets, total liabilities, net worth, current monthly income, current monthly spending, current monthly savings, investment risk, liquidity, leverage, etc., based on changes caused by user interactions with one or more of the interactive components 306j, visualizations, and the configurable parameters. The adapted current metrics are projected for different time instances, for example, “T”, “T+1”, etc. In an example, the RTFP tool 205 computes the total assets at time instances “T”, “T+1”, “T+2”, “T+3”, “T+4”, “T+5”, and “T+30” as “$1,057,190”, “$1,112,389”, “$1,147,502”, “$1,174,073”, “$1,191,471”, “$1,199,030”, and “$4,063,842” respectively, as exemplarily illustrated in FIG. 12. An addition of a baby event at time instance “T+2” affects the spending for subsequent time instances. For example, a user who wishes to understand the impact of cutting back on spending by “$1000” represented as “1” and a baby event represented as “2” impacts the adapted current metrics and financial projections of the adapted current metrics at different time instances as exemplarily illustrated in FIG. 12. The financial management platform 306 renders the computed current metrics, the dynamically adapted current metrics, and the financial projections of the adapted current metrics on a dynamic timeline graph as exemplarily illustrated in FIG. 6.

It will be readily apparent that the various methods and algorithms disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a like device. Non-transitory computer readable media comprise all computer readable media, for example, non-volatile media, volatile media, and transmission media, except for a transitory, propagating signal. Non-volatile media comprise, for example, optical disks or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire and fiber optics, including wires that constitute a system bus coupled to a processor. Common forms of computer readable media comprise, for example, a floppy disk, a flexible disk, a hard disk, magnetic tape, any other magnetic medium, a compact disc-read only memory (CD-ROM), a digital versatile disc (DVD), any other optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read. A “processor” refers to any one or more microprocessors, central processing unit (CPU) devices, computing devices, microcontrollers, digital signal processors, or like devices. Typically, a processor receives instructions from a memory or like device and executes those instructions, thereby performing one or more processes defined by those instructions. Further, programs that implement such methods and algorithms may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of languages that can be used comprise C, C++, C#, Perl, Python, or JAVA. The computer program codes or software programs may be stored on or in one or more mediums as object code. The computer program product disclosed herein comprises computer executable instructions embodied in a non-transitory computer readable storage medium, wherein the computer program product comprises computer program codes for implementing the processes of various embodiments.

Where databases are described such as the database 306k and the RTBI/FMP data repository 210, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment including a computer that is in communication with one or more devices via a communication network. The computer may communicate with the devices directly or indirectly, via a wired medium or a wireless medium such as the Internet, a local area network (LAN), a wide area network (WAN) or the Ethernet, token ring, or via any appropriate communications means or combination of communications means. Each of the devices may comprise computers such as those based on the Intel® processors, AMD® processors, UltraSPARC® processors, IBM® processors, etc., that are adapted to communicate with the computer. Any number and type of machines may be in communication with the computer.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

1. A computer implemented method for managing financial data in real time, comprising:
providing a financial management platform comprising at least one processor configured to manage said financial data in said real time, wherein said financial management platform is accessible by one or more user devices via a network;
providing a plurality of interactive components on a graphical user interface of said financial management platform, wherein said interactive components are configured to acquire user interactions with said financial data on said graphical user interface;
aggregating and categorizing said financial data from a plurality of financial user accounts by said financial management platform;
generating an N-dimensional financial format configured to store and render said aggregated and categorized financial data in a transformed and modifiably categorized configuration on said graphical user interface, by said financial management platform, wherein said N-dimensional financial format is implemented in a computer memory storing said financial data in one of an indexed and a non-indexed data structures, wherein said N-dimensional financial format stores relationships between said financial data using one or more data structures comprising trees, dictionaries, maps, graphs, and arrays, and wherein said N-dimensional financial format is used by said financial management platform to one or more of query, aggregate, combine, and perform manipulations of said financial data across multiple dimensions;
computing current metrics by said financial management platform using said aggregated and categorized financial data stored in said N-dimensional financial format;
dynamically adapting said computed current metrics by said financial management platform in said real time to reflect changes caused by said user interactions with one or more of said interactive components and visualizations of said rendered financial data in said N-dimensional financial format on said graphical user interface; and
generating dynamic real-time financial projections based on said computed current metrics, said dynamically adapted current metrics, and one or more configurable parameters by said financial management platform.

2. The computer implemented method of claim 1, wherein said N-dimensional financial format is configured to facilitate multiple real-time permutations of said aggregated and categorized financial data, and computations against said aggregated and categorized financial data.

3. The computer implemented method of claim 1, wherein said one or more configurable parameters for generating said dynamic real-time financial projections comprise user events, market events, a product recommendation overlay, and any combination thereof.

4. The computer implemented method of claim 1, further comprising performing a comparative analysis of user events collectively dependent on each other by said financial management platform to determine and display impact of one of said user events on another one or more of said user events on said graphical user interface.

5. The computer implemented method of claim 1, further comprising generating a dynamic timeline graph configured to render said computed current metrics, said dynamically adapted current metrics, and said generated dynamic real-time financial projections on said graphical user interface by said financial management platform, wherein said dynamic timeline graph is further configured to support direct real-time user interactions with said computed current metrics, said dynamically adapted current metrics, and said generated dynamic real-time financial projections on said graphical user interface.

6. The computer implemented method of claim 1, further comprising adjusting said generated dynamic real-time financial projections by said financial management platform to account for changes in one or more of current tax rates, future tax rates, inflation rates, foreign exchange rates, and any combination thereof.

7. The computer implemented method of claim 1, further comprising integrating a business intelligence platform comprising at least one processor with said financial management platform, wherein said business intelligence platform is accessible by one or more of a plurality of third parties via a network, and wherein said financial management platform is configured to provide real-time access of financial information comprising said aggregated and categorized financial data, said computed current metrics, said dynamically adapted current metrics, results of said user interactions with said one or more of said interactive components and said visualizations of said rendered financial data in said N-dimensional financial format, and said generated dynamic real-time financial projections, to said business intelligence platform and to said one or more of said third parties via said business intelligence platform for one or more of performing data analysis and market segmentation analysis, adapting business decisions in said real time, and monitoring financial institutions associated with said financial user accounts.

8. The computer implemented method of claim 7, further comprising receiving one or more recommendations on one or more products, services, and investment ideas made by said one or more of said third parties using said real-time access of said financial information, by said business intelligence platform via one or more application programming interfaces of said financial management platform, wherein said financial management platform, in communication with said business intelligence platform, is configured to transmit said received one or more recommendations to said one or more user devices via said network.

9. The computer implemented method of claim 7, further comprising facilitating real-time communication between said one or more user devices and one or more financial institutions and among said third parties by said business intelligence platform via said network in one or more of a plurality of communication modes.

10. The computer implemented method of claim 7, further comprising categorizing business intelligence data and user interactions with said third parties into one or more categories across time by said business intelligence platform based on predetermined criteria, wherein said predetermined criteria comprise one or more of user demographics, type of investment ideas, said financial institutions associated with said financial user accounts, attributes of said financial data, and any combination thereof, for determining and analyzing consumer trends.

11. The computer implemented method of claim 7, further comprising generating analytical reports by said business intelligence platform based on changes in said aggregated and categorized financial data, market data, and economic data.

12. The computer implemented method of claim 1, further comprising:
categorizing transaction data of said financial user accounts extracted from said aggregated and categorized financial data into spend categories by said financial management platform;
acquiring boundary conditions on spending for each of said spend categories by said financial management platform to generate a budget; and
facilitating tracking of said generated budget against subsequent said spending, by said financial management platform.

13. The computer implemented method of claim 1, further comprising generating one or more financial goals as a result of said user interactions through said one or more of said interactive components and said visualizations of said rendered financial data in said N-dimensional financial format by said financial management platform, wherein said financial management platform is configured to collectively prioritize, manage, and track each of said generated one or more financial goals against said financial user accounts.

14. The computer implemented method of claim 1, further comprising generating an optimized refinanced debt structure by said financial management platform based on one or more of loan information provided by one or more financial institutions, an existing debt structure of a user, and liquid assets of said user.

15. The computer implemented method of claim 14, wherein said generation of said optimized refinanced debt structure by said financial management platform comprises generating an interest rate structure using user configurable filters on said loan information.

16. The computer implemented method of claim 1, further comprising acquiring user inputs by said financial management platform via said graphical user interface, wherein said financial management platform is configured to overlay said acquired user inputs on said rendered financial data in said N-dimensional financial format to perform a prospective analysis of financial decisions and determine current financial status and future financial status.

17. A computer implemented system for managing financial data in real time, comprising:
a financial management platform comprising:
at least one processor;
a non-transitory computer readable storage medium communicatively coupled to said at least one processor, said non-transitory computer readable storage medium configured to store modules of said financial management platform, said at least one processor configured to execute said modules of said financial management platform;
said modules of said financial management platform comprising:
a graphical user interface comprising a plurality of interactive components configured to acquire user interactions with said financial data;
a financial data aggregation module configured to aggregate said financial data from a plurality of financial user accounts;
a categorization engine configured to categorize said aggregated financial data based on characteristics of said financial data;
a financial format generation module configured to generate an N-dimensional financial format, said N-dimensional financial format configured to store and render said aggregated and categorized financial data in a transformed and modifiably categorized configuration on said graphical user interface, wherein said N-dimensional financial format is implemented in a computer memory storing said financial data in one of an indexed and a non-indexed data structures, wherein said N-dimensional financial format stores relationships between said financial data using one or more data structures comprising trees, dictionaries, maps, graphs, and arrays, and wherein said N-dimensional financial format is used by said financial management platform to one or more of query, aggregate, combine, and perform manipulations of said financial data across multiple dimensions;
a metrics computation module configured to compute current metrics using said aggregated and categorized financial data stored in said N-dimensional financial format;
said metric computation module configured to dynamically adapt said computed current metrics in said real time to reflect changes caused by said user interactions with one or more of said interactive components and visualizations of said rendered financial data in said N-dimensional financial format on said graphical user interface; and
a financial projection generation module configured to generate dynamic real-time financial projections based on said computed current metrics, said dynamically adapted current metrics, and one or more configurable parameters.

18. The computer implemented system of claim 17, wherein said N-dimensional financial format is configured to facilitate multiple real-time permutations of said aggregated and categorized financial data, and computations against said aggregated and categorized financial data.

19. The computer implemented system of claim 17, wherein said one or more configurable parameters for generating said dynamic real-time financial projections comprise user events, market events, a product recommendation overlay, and any combination thereof.

20. The computer implemented system of claim 17, wherein said modules of said financial management platform further comprise a dynamic timeline graph generation module configured to generate a dynamic timeline graph, wherein said dynamic timeline graph is configured to render said computed current metrics, said dynamically adapted current metrics, and said generated dynamic real-time financial projections on said graphical user interface, and wherein said dynamic timeline graph is further configured to support direct real-time user interactions with said computed current metrics, said dynamically adapted current metrics, and said generated dynamic real-time financial projections on said graphical user interface.

21. The computer implemented system of claim 17, wherein said financial projection generation module is further configured to perform a comparative analysis of user events collectively dependent on each other to determine and display impact of one of said user events on another one or more of said user events on said graphical user interface.

22. The computer implemented system of claim 17, wherein said financial projection generation module is configured to adjust said generated dynamic real-time financial projections to account for changes in one or more of current tax rates, future tax rates, inflation rates, foreign exchange rates, and any combination thereof.

23. The computer implemented system of claim 17, further comprising a business intelligence platform integrated with said financial management platform, wherein said business intelligence platform comprises at least one processor configured to execute modules of said business intelligence platform, and wherein said business intelligence platform is accessible by one or more of a plurality of third parties via a network, and wherein said financial management platform is configured to provide real-time access of financial information comprising said aggregated and categorized financial data, said computed current metrics, said dynamically adapted current metrics, results of said user interactions with said one or more of said interactive components and said visualizations of said rendered financial data in said N-dimensional financial format, and said generated dynamic real-time financial projections, to said business intelligence platform and to said one or more of said third parties via said business intelligence platform for one or more of performing data analysis and market segmentation analysis, adapting business decisions in said real time, and monitoring financial institutions associated with said financial user accounts.

24. The computer implemented system of claim 23, wherein said modules of said business intelligence platform comprise one or more of:
a communication module configured to receive one or more recommendations on one or more products, services, and investment ideas made by said one or more of said third parties using said real-time access of said financial information, via one or more application programming interfaces of said financial management platform, wherein said financial management platform, in communication with said business intelligence platform, is configured to transmit said received one or more recommendations to said one or more user devices via said network;
a categorization engine configured to categorize business intelligence data and user interactions with said third parties into one or more categories across time based on predetermined criteria, wherein said predetermined criteria comprise one or more of user demographics, type of investment ideas, said financial institutions associated with said financial user accounts, attributes of said financial data, and any combination thereof, for determining and analyzing consumer trends; and
a report generation module configured to generate analytical reports based on changes in said aggregated and categorized financial data, market data, and economic data.

25. The computer implemented system of claim 17, wherein said categorization engine of said financial management platform is further configured to categorize transaction data of said financial user accounts extracted from said aggregated and categorized financial data into spend categories, wherein said financial projection generation module is configured to acquire boundary conditions on spending for each of said spend categories to generate a budget, and facilitate tracking of said generated budget against subsequent said spending.

26. The computer implemented system of claim 17, wherein said modules of said financial management platform further comprise a financial goal generation module configured to generate one or more financial goals as a result of said user interactions through said one or more of said interactive components and said visualizations of said rendered financial data in said N-dimensional financial format, wherein said financial goal generation module is further configured to collectively prioritize, manage, and track each of said generated one or more financial goals against said financial user accounts.

27. The computer implemented system of claim 17, wherein said modules of said financial management platform further comprise a refinanced debt structure generation module configured to generate an optimized refinanced debt structure based on one or more of loan information provided by one or more financial institutions, an existing debt structure of a user, and liquid assets of said user.

28. The computer implemented system of claim 17, wherein said financial format generation module is configured to acquire user inputs via said graphical user interface, and wherein said financial format generation module is configured to overlay said acquired user inputs on said rendered financial data in said N-dimensional financial format to configure said financial projection generation module to perform a prospective analysis of financial decisions and determine current financial status and future financial status.

29. A computer program product comprising a non-transitory computer readable storage medium, said non-transitory computer readable storage medium storing computer program codes that comprise instructions executable by at least one processor, said computer program codes comprising:
a first computer program code for aggregating financial data from a plurality of financial user accounts;
a second computer program code for categorizing said aggregated financial data based on characteristics of said financial data;
a third computer program code for generating an N-dimensional financial format configured to store and render said aggregated and categorized financial data in a transformed and modifiably categorized configuration on a graphical user interface, wherein said N-dimensional financial format is implemented in a computer memory storing said financial data in one of an indexed and a non-indexed data structures, wherein said N-dimensional financial format stores relationships between said financial data using one or more data structures comprising trees, dictionaries, maps, graphs, and arrays, and wherein said N-dimensional financial format is used by said financial management platform to one or more of query, aggregate, combine, and perform manipulations of said financial data across multiple dimensions;
a fourth computer program code for computing current metrics using said aggregated and categorized financial data stored in said N-dimensional financial format;
a fifth computer program code for dynamically adapting said computed current metrics in real time to reflect changes caused by user interactions with one or more interactive components and visualizations of said rendered financial data in said N-dimensional financial format on said graphical user interface; and
a sixth computer program code for generating dynamic real-time financial projections based on said computed current metrics, said dynamically adapted current metrics, and one or more configurable parameters.

30. The computer program product of claim 29, wherein said computer program codes further comprise a seventh computer program code for providing real-time access of financial information comprising said aggregated and categorized financial data, said computed current metrics, said dynamically adapted current metrics, results of said user interactions with said one or more interactive components and said visualizations of said rendered financial data in said N-dimensional financial format, and said generated dynamic real-time financial projections, to a business intelligence platform and to one or more of a plurality of third parties via said business intelligence platform for one or more of performing data analysis and market segmentation analysis, adapting business decisions in said real time, and monitoring financial institutions associated with said financial user accounts.
